(19) United States
(12) Patent Application Publication
(10) Pub. No.: US 2013/0253802 A1
(43) Pub. Date: Sep. 26, 2013

(54) INTER-CYLINDER AIR-FUEL RATIO IMBALANCE DETECTION APPARATUS FOR INTERNAL COMBUSTION ENGINE

(71) Applicants: Hiroshi Miyamoto, Suntou-gun Shizuoka-ken (JP); Kenji Suzuki, Susono-shi Shizuoka-ken (JP); Yasushi Iwazaki, Ebina-shi Kanagawa-ken (JP); Takanori Sasaki, Susono-shi Shizuoka-ken (JP)

(72) Inventors: Hiroshi Miyamoto, Suntou-gun Shizuoka-ken (JP); Kenji Suzuki, Susono-shi Shizuoka-ken (JP); Yasushi Iwazaki, Ebina-shi Kanagawa-ken (JP); Takanori Sasaki, Susono-shi Shizuoka-ken (JP)

(73) Assignee: Toyota Jidosha Kabushiki Kaisha, Toyota-shi Aichi-ken (JP)

(21) Appl. No.: 13/827,660

(22) Filed: Mar. 14, 2013

(30) Foreign Application Priority Data
Mar. 22, 2012 (JP) 2012-065868
Oct. 4, 2012 (JP) 2012-222229

(51) Int. Cl. F02D 43/04

(52) U.S. Cl. CPC F02D 43/04
USPC 701/103

(57) ABSTRACT

An air-fuel ratio imbalance detection apparatus includes an air-fuel ratio sensor that is arranged in an exhaust passage of an internal combustion engine and that includes an electrode and a diffusion layer provided on the electrode; an estimating unit configured to estimate or detect an output variation amount that is an amount of variation in an output of the air-fuel ratio sensor due to an influence of a pressure pulsation of exhaust gas from the internal combustion engine; and a determination unit configured to determine whether there is an air-fuel ratio imbalance among cylinders of the internal combustion engine, on the basis of the output variation amount and a determination value based on the output of the air-fuel ratio sensor.

### INCORPORATION BY REFERENCE

The disclosure of Japanese Patent Application No. 2012-222229 filed on Oct. 4, 2012 including the specification, drawings and abstract is incorporated herein by reference in its entirety.

### BACKGROUND OF THE INVENTION

1. Field of the Invention

The invention relates to an inter-cylinder air-fuel ratio imbalance detection apparatus for an internal combustion engine. More specifically, the invention relates to an air-fuel ratio imbalance detection apparatus that determines whether there is an air-fuel ratio imbalance among cylinders of a multi-cylinder internal combustion engine on the basis of an output of an air-fuel ratio sensor installed in an exhaust path.

2. Description of Related Art

For example, Japanese Patent Application Publication No. 2009-270543 (JP 2009-270543 A) describes a determination apparatus for determining whether there is an abnormal air-fuel ratio variation among cylinders of a multi-cylinder internal combustion engine. According to JP 2009-270543 A, in a state where there is an abnormal air-fuel ratio variation (hereinafter, also referred to as “imbalance”) among the cylinders, a half-order frequency component of a signal from the air-fuel ratio sensor is high. In the determination apparatus described in JP 2009-270543 A, a half-order frequency component of an engine rotation speed is extracted from a signal that indicates an air-fuel ratio detected by the air-fuel ratio sensor, and the extracted signal is accumulated for a predetermined period. When the accumulated value is larger than a threshold, it is determined that there is an air-fuel ratio imbalance among the cylinders.

As described in the JP 2009-270543 A, in the determination apparatus for an imbalance among the cylinders, which utilizes an output signal of the air-fuel ratio sensor, if there is an abnormality in the air-fuel ratio sensor, erroneous determination may be made, for example, it may be determined that there is no imbalance (it is normal) even when there is an imbalance.

An output of the air-fuel ratio sensor receives the influence of a pressure pulsation of exhaust gas, and there is a variation in the influence of a pressure pulsation due to an individual difference among air-fuel ratio sensors. Thus, as described in JP 2009-270543 A, when a filtered value of a specific frequency component of an output of the air-fuel ratio sensor is used, there may be a variation in the filtered value and a variation in an accumulated value of the filtered value due to the variation due to individual difference and the influence of the pressure pulsation. In such a case, erroneous determination as to an imbalance among the cylinders can be made. Thus, there is a need for a system that is able to further highly accurately determine whether there is an imbalance among the cylinders.

### SUMMARY OF THE INVENTION

The invention provides an air-fuel ratio imbalance detection apparatus that is improved so as to be able to further highly accurately determine whether there is an air-fuel ratio imbalance among cylinders while suppressing erroneous determination due to an abnormal air-fuel ratio sensor when determining whether there is an air-fuel ratio imbalance among the cylinders.

An aspect of the invention relates to an air-fuel ratio imbalance detection apparatus for an internal combustion engine. The air-fuel ratio imbalance detection apparatus includes an air-fuel ratio sensor that is arranged in an exhaust passage of the internal combustion engine and that includes an electrode and a diffusion layer provided on the electrode; an estimating unit configured to estimate or detect an output variation amount that is an amount of variation in an output of the air-fuel ratio sensor due to an influence of a pressure pulsation of exhaust gas from the internal combustion engine; and a determination unit configured to determine whether there is an air-fuel ratio imbalance among cylinders of the internal combustion engine, on the basis of the output variation amount and a determination value based on the output of the air-fuel ratio sensor.

According to the above aspect of the invention, it is possible to estimate or detect the output variation amount that is an amount of variation in the output of the air-fuel ratio sensor due to an influence of a pressure pulsation and then to detect an air-fuel ratio imbalance (determine whether there is an air-fuel ratio imbalance) on the basis of the output variation amount and the output of the air-fuel ratio sensor. In one cycle of the internal combustion engine, the output of the air-fuel ratio sensor fluctuates upon reception of the influence of an air-fuel ratio variation among the cylinders and the influence of a pressure pulsation. In terms of this point, it is possible to detect an air-fuel ratio imbalance (determine whether there is an air-fuel ratio imbalance) by estimating or detecting an output variation amount due to the influence of the pressure pulsation and then removing the output variation amount due to the influence of the pressure pulsation from an actual output of the air-fuel ratio sensor. By so doing, according to the above aspect of the invention, it is possible to further highly accurately detect an air-fuel ratio imbalance (determine whether there is an air-fuel ratio imbalance) on the basis of only an output fluctuation in the output of the air-fuel ratio sensor, which is caused due to an air-fuel ratio variation among the cylinders.

In the above aspect of the invention, the estimating unit may estimate or detect an amplitude of the output of the air-fuel ratio sensor or a value corresponding to the amplitude, as the output variation amount. The estimating unit may estimate or detect the output variation amount on the basis of the output of the air-fuel ratio sensor during fuel cut operation of the internal combustion engine.

Particularly, the influence of the pressure pulsation appears in an amplitude of the output of the air-fuel ratio sensor or a variation in the amplitude in one cycle. Thus, by using the amplitude or a value corresponding to the amplitude as the output variation amount due to the influence of the pressure pulsation, it is possible to further highly accurately detect an air-fuel ratio imbalance (determine whether there is an air-fuel ratio imbalance).

Particularly, during fuel cut operation, there is no air-fuel ratio variation among the cylinders. Thus, the amount of variation in the sensor output during fuel cut operation is presumably due to only the influence of the pressure pulsation. Thus, by using the output variation amount during fuel cut operation, it is possible to remove the influence of the pressure pulsation from the sensor output at the time when it is determined whether there is an air-fuel ratio variation imbalance. Therefore, it is possible to highly accurately detect an air-fuel ratio imbalance among the cylinders (determine whether there is an air-fuel ratio imbalance).

The air-fuel ratio imbalance detection apparatus according to the above aspect of the invention may further include a first unit configured to estimate or detect a pressure pulsation that is received by a sensor element of the air-fuel ratio sensor due to the pressure pulsation of exhaust gas from the internal combustion engine; and a second unit configured to estimate or detect a first amplitude and a second amplitude. The first amplitude is an amplitude of the output of the air-fuel ratio sensor, and the second amplitude is an amplitude of the output of the air-fuel ratio sensor at timing at which the pressure pulsation is different from the pressure pulsation at a time when the first amplitude is estimated or detected. In this case, the estimating unit estimates the output variation amount on the basis of a difference between the first amplitude and the second amplitude and a difference between the pressure pulsation at the time when the first amplitude is estimated or detected and the pressure pulsation at a time when the second amplitude is estimated or detected.

In the above aspect of the invention, in the configuration in which the first amplitude and the second amplitude are estimated or detected, timing at which the first amplitude is estimated or detected and the timing at which the second amplitude is estimated or detected may be (i) timings during fuel cut operation of the internal combustion engine, (ii) timings which are during a stop of air-fuel ratio feedback control, and at which a same target air-fuel ratio is set, or (iii) timings which are during the air-fuel ratio feedback control, and at which a same target air-fuel ratio that falls outside a reference range including a stoichiometric air-fuel ratio is set.

The air-fuel ratio imbalance detection apparatus according to the above aspect of the invention may further include a third unit configured to set a target air-fuel ratio to a rich or lean air-fuel ratio that falls outside a reference range including a stoichiometric air-fuel ratio when air-fuel ratio feedback control operation of the internal combustion engine is being performed and the target air-fuel ratio is set so as to fall within the reference range; and a fourth unit configured to execute control for forcibly fluctuating the pressure pulsation when the feedback control operation is being performed with the target air-fuel ratio being set to the rich or lean air-fuel ratio. In this case, timing at which the first amplitude is estimated or detected and the timing at which the second amplitude is estimated or detected are during the control for forcibly fluctuating the pressure pulsation.

In the above aspect of the invention, in the configuration in which the timing at which the first amplitude is estimated or detected and the timing at which the second amplitude is estimated or detected are timings during fuel cut operation of the internal combustion engine, timings which are during a stop of air-fuel ratio feedback control, timings which are during the air-fuel ratio feedback control, and during operation with the target air-fuel ratio being set so as to fall outside a reference range including a stoichiometric air-fuel ratio, or timings which are during the control for forcibly fluctuating the pressure pulsation, it is possible to estimate or detect the first amplitude and the second amplitude in an environment in which the influence due to an air-fuel ratio imbalance is almost constant. Thus, it is possible to further highly accurately determine whether there is an air-fuel ratio imbalance.

The air-fuel ratio imbalance detection apparatus according to the above aspect of the invention may further include a fifth unit configured to determine that there is an abnormality in the air-fuel ratio sensor when the output variation amount falls outside a predetermined range.

When the influence of the pressure pulsation on the output of the air-fuel ratio sensor is excessively small or excessively large, it is presumable that there is an abnormality in the diffusion layer of the sensor element. In terms of this point, in the configuration according to the above aspect of the invention, in which it is determined that there is an abnormality in the air-fuel ratio sensor when the output variation amount falls outside the predetermined range, it is also possible to detect an abnormality in the air-fuel ratio sensor (determine whether there is an abnormality in the air-fuel ratio sensor) at the time of determining whether there is an air-fuel ratio imbalance. By so doing, it is possible to suppress erroneous determination that there is an air-fuel ratio imbalance due to an abnormal air-fuel ratio sensor.

In the above aspect of the invention, the determination value may be an amplitude of the output of the air-fuel ratio sensor in one cycle of the internal combustion engine when it is determined whether there is the air-fuel ratio imbalance. The determination value may be a rate of variation in the output of the air-fuel ratio sensor per unit crank angle.

In the above aspect of the invention, the determination unit may determine that there is the air-fuel ratio imbalance when a value obtained by correcting the determination value on the basis of the output variation amount exceeds a reference value. The determination unit may determine that there is the air-fuel ratio imbalance when the determination value exceeds a value obtained by correcting a reference value on the basis of the output variation amount.

In the above aspect of the invention, when an operation time of the internal combustion engine exceeds a reference time or a travel distance of a vehicle on which the internal combustion engine is mounted exceeds a reference distance after the estimating unit estimates or detects the output variation amount, the estimating unit may estimate or detect the output variation amount again.

In the above aspect of the invention, the determination unit may determine whether there is the air-fuel ratio imbalance on the basis of the output variation amount, an intake air flow rate during a period in which the output variation amount is estimated or detected, and the determination value.

A sensor output variation amount during fuel cut operation also varies due to the intake air flow rate in addition to the influence of the pressure pulsation. Thus, in the configuration in which the sensor output variation amount during fuel cut operation is used in determining whether there is an air-fuel ratio imbalance, it is possible to further highly accurately determine whether there is an air-fuel ratio imbalance by additionally taking the intake air flow rate into consideration.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view for illustrating the overall configuration of a system according to a first embodiment of the invention;

FIG. 2A and FIG. 2B are schematic views for illustrating the configuration of a sensor element of an air-fuel ratio sensor according to the first embodiment of the invention;

FIG. 3 is a graph for illustrating a variation in output of the air-fuel ratio sensor with respect to a variation in pressure pulsation;

FIG. 4 is a graph for illustrating the correlation between a variation in pressure pulsation and a variation in amplitude of the output of the air-fuel ratio sensor, which is used in the first embodiment of the invention;

FIG. 5 is a graph for illustrating the correlation between a variation in imbalance ratio and a variation in amplitude of the output of the air-fuel ratio sensor, which is used in the first embodiment of the invention;

FIG. 6 is a graph for illustrating the correlation among an imbalance ratio, an amplitude of the output of the air-fuel ratio sensor and a pressure pulsation, which is used in the first embodiment of the invention;

FIG. 7 is a view for illustrating a map that defines the correlation among a rotation speed, valve timing, an intake air flow rate and a pressure pulsation, which is used in the first embodiment of the invention;

FIG. 8 is a graph for illustrating abnormality determination for the air-fuel ratio sensor and imbalance determination in the first embodiment of the invention;

FIG. 9 is a graph for illustrating abnormality determination for the air-fuel ratio sensor and imbalance determination in the first embodiment of the invention;

FIG. 10 is a flowchart for illustrating the routine of control that is executed by a control unit in the first embodiment of the invention;

FIG. 11 is a graph for illustrating the correlation between an intake air flow rate of an internal combustion engine and a slope of a sensor output;

FIG. 12 is a graph for illustrating the correlation between an intake air flow rate and an amplitude rate during fuel cut operation of the internal combustion engine;

FIG. 13 is a graph for illustrating the correlation between an amplitude rate and a slope of the sensor output during fuel cut operation of the internal combustion engine;

FIG. 14 is a graph for illustrating the correlation between an amplitude rate and a correction coefficient during fuel cut operation in a second embodiment of the invention;

FIG. 15A and FIG. 15B are graphs for respectively illustrating a slope of an uncorrected sensor output and a slope of a sensor output corrected in the second embodiment of the invention;

FIG. 16 is a flowchart for illustrating the routine of control that is executed by a control unit in the second embodiment of the invention;

FIG. 17 is a flowchart for illustrating the routine of control that is executed by the control unit in the second embodiment of the invention;

FIG. 18 is a flowchart for illustrating the routine of control that is executed by the control unit in the second embodiment of the invention;

FIG. 19 is a flowchart for illustrating the routine of control that is executed by the control unit in the second embodiment of the invention;

FIG. 20 is a flowchart for illustrating the routine of control that is executed by a control unit in a third embodiment of the invention;

FIG. 21 is a flowchart for illustrating the routine of control that is executed by the control unit in the third embodiment of the invention;

FIG. 22 is a flowchart for illustrating the routine of control that is executed by the control unit in the third embodiment of the invention;

FIG. 23 is a graph for illustrating the correlation between an amplitude rate and an intake air flow rate during fuel cut operation of the internal combustion engine;

FIG. 24 is a graph for illustrating the correlation between a slope correction coefficient that is calculated through control according to the second embodiment of the invention and an intake air flow rate;

FIG. 25 is a graph for illustrating the correlation between an intake air flow rate and an amplitude rate correction coefficient in a fourth embodiment of the invention;

FIG. 26 is a view for illustrating the correlation between an intake air flow rate and a slope correction coefficient in the fourth embodiment of the invention;

FIG. 27 is a flowchart for illustrating the routine of control that is executed by a control unit in the fourth embodiment of the invention; and

FIG. 28 is a flowchart for illustrating the routine of control that is executed by the control unit in the fourth embodiment of the invention.

### DETAILED DESCRIPTION OF EMBODIMENTS

### First Embodiment

### Configuration of Air-fuel Ratio Sensor and Its Peripheral Devices According to First Embodiment

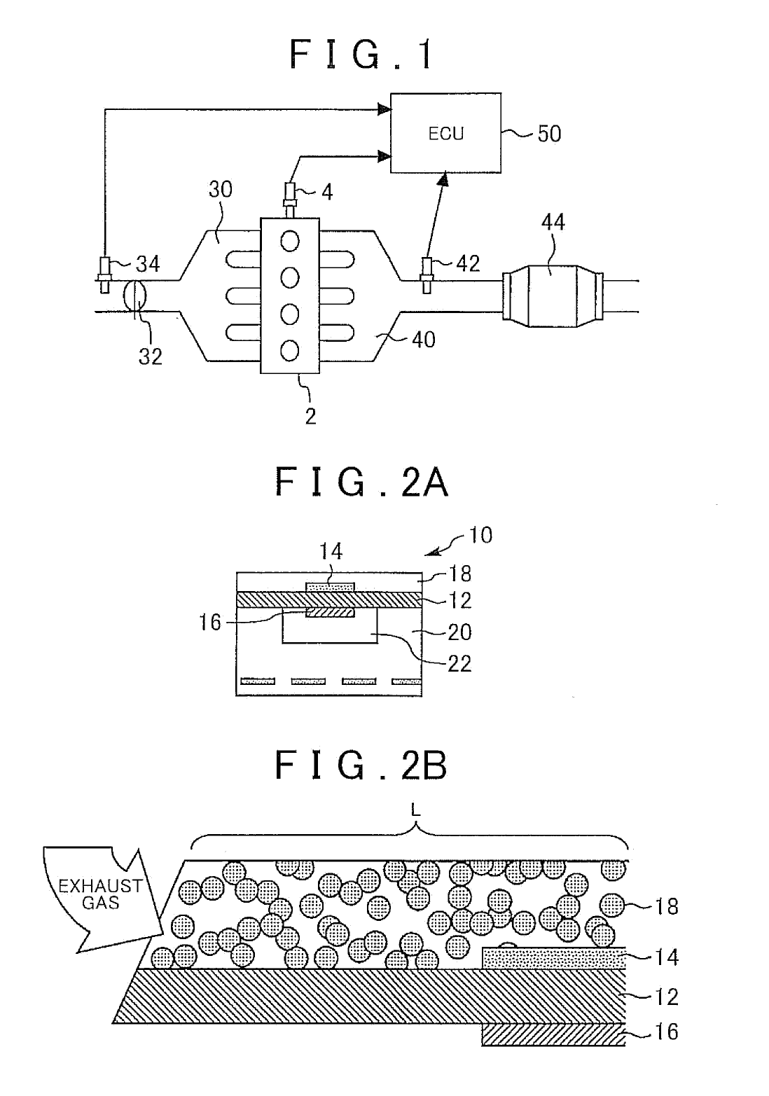

FIG. 1 is a schematic view for illustrating the overall configuration of a system according to a first embodiment of the invention. The system shown in FIG. 1 is mounted on a vehicle, or the like, and is used. The system includes an internal combustion engine 2. A crank angle sensor 4 is arranged near a crankshaft of the internal combustion engine 2. The crank angle sensor 4 is a sensor that generates an output corresponding to a crank angle.

A throttle valve 32 is installed in an intake path 30 of the internal combustion engine 2. An air flow meter 34 is installed upstream of the throttle valve 32. The air flow meter 34 is a sensor that generates an output corresponding to an intake air flow rate. On the other hand, an air-fuel ratio sensor 42 is installed in an exhaust path 40 of the internal combustion engine 2. The air-fuel ratio sensor 42 is a limiting current sensor that generates an output corresponding to the air-fuel ratio of gas that is a detected target. A catalyst 44 is arranged downstream of the air-fuel ratio sensor 42.

The system includes a control unit 50. Various actuators are connected to the output side of the control unit 50. Various sensors in addition to the crank angle sensor 4, the air flow meter 34 and the air-fuel ratio sensor 42 are connected to the input side of the control unit 50. The control unit 50 detects the air-fuel ratio of exhaust gas, the crank angle, the intake air flow rate and the engine rotation speed and other various pieces of information, which are required to operate the internal combustion engine, upon reception of various sensor signals, and operates each actuator in accordance with a predetermined control program. Many actuators and sensors are connected to the control unit 50; however, the description thereof is omitted in this specification.

FIG. 2A and FIG. 2B are schematic sectional views for illustrating a sensor element 10 of the air-fuel ratio sensor 42 that is used in the system according to the first embodiment of the invention. FIG. 2A shows the overall configuration of the sensor element 10. FIG. 2B shows part of the sensor element in enlarged view. The air-fuel ratio sensor 42 includes the sensor element 10 and a cover (not shown). The sensor element 10 has a cross-sectional structure shown in FIG. 2A and FIG. 2B. The cover is used to protect the sensor element 10. The air-fuel ratio sensor 42 is fitted to an exhaust passage of the internal combustion engine such that the sensor element 10 covered with the cover is exposed to exhaust gas. The cover of the air-fuel ratio sensor 42 has a plurality of vent holes such that exhaust gas flowing inside the exhaust passage reaches the sensor element 10.

As shown in FIG. 2A and FIG. 2B, the sensor element 10 includes a solid electrolyte 12, an exhaust-side electrode 14 and an atmosphere-side electrode 16. The exhaust-side electrode 14 and the atmosphere-side electrode 16 serve as a pair of electrodes that sandwich the solid electrolyte 12. A diffusion layer 18 is formed on the surface of the exhaust-side electrode 14 so as to cover the exhaust-side electrode 14. The diffusion layer 18 is formed of a porous material, and has the function of homogenizing exhaust gas flowing through the exhaust passage and adequately controlling the rate of the flow.

On the other hand, an electrical insulating base member 20 is arranged at a side at which the atmosphere-side electrode 16 of the solid electrolyte 12 is arranged. The electrical insulating base member 20 has a recess. An atmospheric chamber 22 is defined by the recess and the solid electrolyte 12. The atmosphere-side electrode 16 is arranged inside the atmospheric chamber 22 of the solid electrolyte 12. Atmosphere that serves as reference gas is introduced from an outside into the atmospheric chamber 22. The surface of the atmosphere-side electrode 16 is in contact with atmosphere that is introduced into the atmospheric chamber 22.

### Control of First Embodiment

In the first embodiment, control that is executed by the control unit 50 includes control for detecting an abnormality in the air-fuel ratio sensor 42 and determining whether there is an abnormal variation in air-fuel ratio among the cylinders (hereinafter, an abnormal variation in air-fuel ratio among the cylinders may be also simply referred to as “imbalance” (or “inter-cylinder air-fuel ratio imbalance”)).

### Determination as to Whether There is Imbalance

An existing system, for example, detects an imbalance on the basis of a step response that is one of indices of the response characteristic of the air-fuel ratio sensor. However, a fluctuation cycle of the air-fuel ratio of exhaust gas within one-cycle operation of the internal combustion engine is generally shorter than a fluctuation cycle of the step response of the air-fuel ratio sensor. Specifically, the fluctuation cycle of the air-fuel ratio of exhaust gas ranges from about 1 ms to 60 ms; whereas the fluctuation cycle of the step response ranges from about 100 ms to 500 ms, so time scales are significantly different. Thus, it is considered to be difficult to highly accurately detect, on the basis of the step response, an abnormality in a variation in the air-fuel ratio of exhaust gas, which occurs in one cycle.

The gas interchangeability of the cover significantly contributes to a fluctuation in the step response, and the arrival rate of exhaust gas in the sensor element 10 and the response characteristic of the sensor element 10 itself significantly influence the behavior of the air-fuel ratio that is detected during one combustion cycle of the internal combustion engine. Thus, when it is possible to determine a variation in the response characteristic of the sensor element 10 itself of the air-fuel ratio sensor 42 in a vehicle-mounted state, it is considered to be possible to highly accurately detect an imbalance among the cylinders by determining an abnormality in a fluctuation in the air-fuel ratio of exhaust gas during one cycle.

The resistance of the diffusion layer and the length of the diffusion layer are dominant in the response characteristic of the sensor element 10 itself. Specifically, as the resistance of the diffusion layer 18 decreases and the length L (see FIG. 2B) of the diffusion layer 18 decreases, the response characteristic tends to increase. In the case of the sensor element having a high response characteristic, the static pressure dependency of the sensor output decreases; however, a pulsation influence increases, that is, dynamic pressure dependency increases. Thus, in order to determine whether there is an imbalance by determining the response characteristic of the sensor element, it is effective to detect a fluctuation in sensor output due to a pulsation influence.

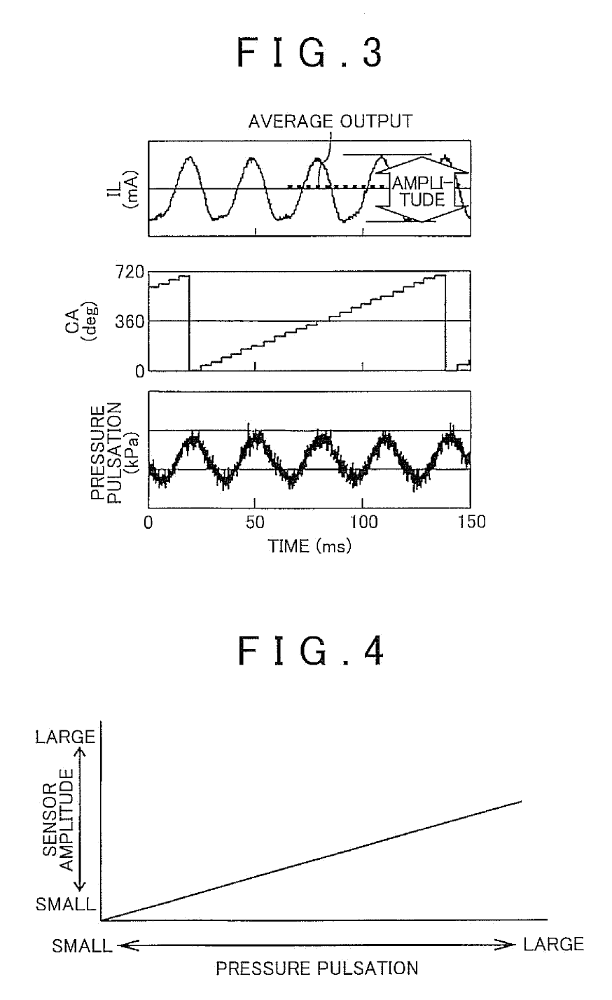

FIG. 3 is a graph that shows a variation in pressure pulsation, a variation in crank angle CA and a variation in limiting current IL that is a sensor output in the case where a pressure pulsation is added. In the example of FIG. 3, the air-fuel ratio of exhaust gas is constant. As shown in FIG. 3, the sensor output pulsates due to the influence of a pressure pulsation even when the air-fuel ratio is constant. At this time, for example, the amplitude of the sensor output (sensor amplitude) increases as the porosity of the diffusion layer 18 increases, and the amplitude of the sensor output increases as the length of the diffusion layer 18 decreases.

FIG. 4 is a graph for illustrating a variation in sensor amplitude with respect to a pressure pulsation in the case where the pressure pulsation of exhaust gas that is a detected target is changed. In FIG. 4, the abscissa axis represents a pressure pulsation, and the ordinate axis represents a sensor amplitude. It is assumed that the magnitude of the pressure pulsation in the first embodiment means the amplitude of the pressure pulsation. In addition, in FIG. 4, the air-fuel ratio of exhaust gas that is a detected target is not changed.

As shown in FIG. 4, in an environment in which the air-fuel ratio is constant, the pressure pulsation and the sensor amplitude vary proportionally, and the sensor amplitude increases as the pressure pulsation increases. In the first embodiment, a variation in the sensor amplitude per unit pressure pulsation (slope in FIG. 4) is defined as a pulsation coefficient ki. The pulsation coefficient ki is a value that is unique to the air-fuel ratio sensor and that indicates the magnitude of the pulsation influence, and is theoretically a value that is obtained as a fixed value in an environment in which the air-fuel ratio of exhaust gas is the same.

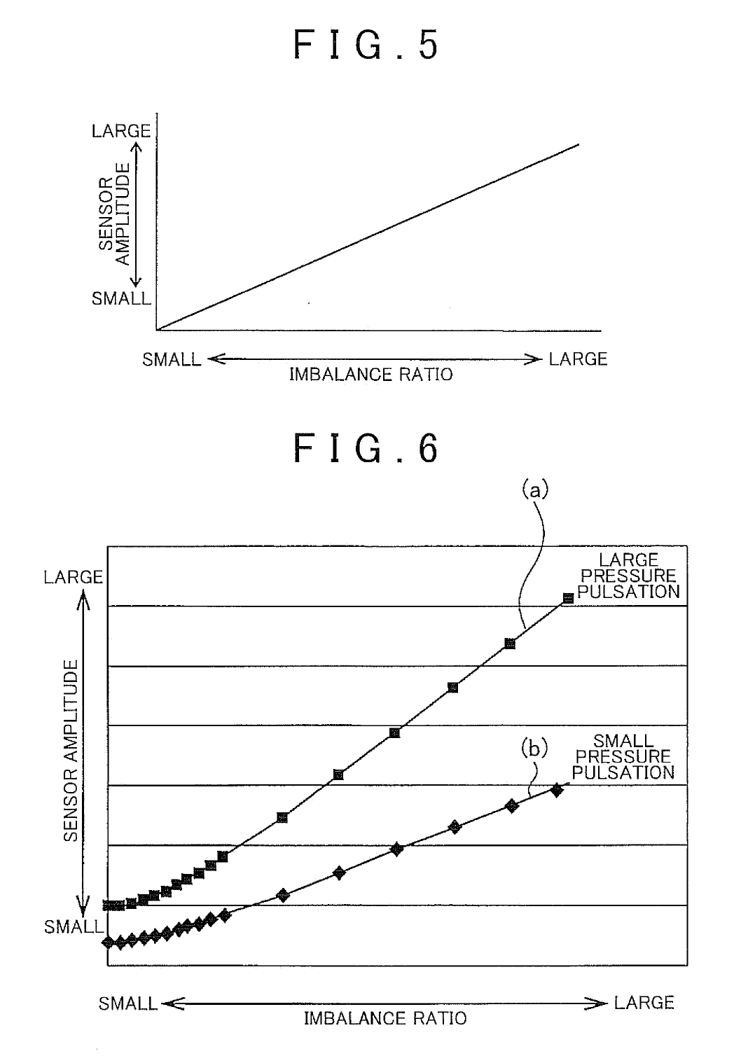

FIG. 5 shows a variation in sensor amplitude with respect to an imbalance ratio of the air-fuel ratio in the case where a variation is caused to occur in the air-fuel ratio among the cylinders (i.e., an inter-cylinder air-fuel ratio imbalance is caused). In FIG. 5, the abscissa axis represents an imbalance ratio, and the ordinate axis represents a sensor amplitude. In the example of FIG. 5, the pressure pulsation is constant. In addition, the imbalance ratio is a value that indicates the degree of imbalance in air-fuel ratio among the cylinders. In FIG. 5, an imbalance state is forcibly created by, for example, changing a fuel injection amount that is injected into each cylinder, and the imbalance ratio here is expressed as the average of actual injection amounts with respect to a reference fuel injection amount.

As shown in FIG. 5, it appears that, in an environment in which the pressure pulsation is constant, the imbalance ratio and the sensor amplitude have a proportional correlation and the sensor amplitude increases as the imbalance ratio increases. When a variation in sensor amplitude per unit variation in imbalance ratio (slope in FIG. 5) is defined as an air-fuel ratio fluctuation rate ΔA/F, the air-fuel ratio fluctuation rate ΔA/F is also a value unique to the air-fuel ratio sensor, and is a value that is theoretically obtained as a fixed value in an environment in which the pressure pulsation is the same.

From the above relationship, the correlation among the sensor amplitude, the pulsation coefficient ki and the air-fuel ratio fluctuation rate ΔA/1⁷ is expressed by the following mathematical expression (1).

Amplitude=α√{(ki)²+(ΔA/F)²}+β (1)

Here, α is a coefficient, and β is a value that is set on the basis of a limiting current.

FIG. 6 is a graph for illustrating a variation in sensor amplitude with respect to an imbalance ratio. In FIG. 6, the abscissa axis represents an imbalance ratio, and the ordinate axis represents a sensor amplitude. In the example shown in FIG. 6, the pressure pulsation is changed. In FIG. 6, a line (a) indicates the case where a pulsation is large, and a line (b) indicates the case where a pulsation is small. The sensor amplitude correlates with an imbalance ratio and a pressure pulsation. Specifically, as shown in FIG. 6, as the imbalance ratio increases and as the pressure pulsation increases, the sensor amplitude increases.

By utilizing the above correlation, in the first embodiment, in an environment in which the air-fuel ratio is constant or a variation in the air-fuel ratio is extremely small, the sensor amplitude and the pressure pulsation are detected or estimated. Furthermore, by utilizing the correlation between the sensor amplitude and the pressure pulsation, the pulsation coefficient ki is calculated as an output variation amount due to the influence of the pressure pulsation. Moreover, by correcting the sensor amplitude using the inverse of the calculated pulsation coefficient ki as a correction coefficient, it is possible to obtain the sensor amplitude from which the pulsation influence has been removed. The sensor amplitude, from which the pulsation influence has been removed, and the imbalance ratio have the correlation as shown in FIG. 5. Thus, imbalance determination is made (it is determined whether imbalance occurs) by using the sensor amplitude corrected using the pulsation coefficient ki as an imbalance determination parameter. Hereinafter, description will be made specifically. Estimation of Sensor Amplitude of Air-fuel Ratio Sensor and Pressure Pulsation

The sensor amplitude at time point i correlates with the pulsation coefficient ki, the air-fuel ratio fluctuation rate ΔA/F, the air flow rate, and the like, and is calculated by the following mathematical expression (2). In the mathematical expression (2), K is a constant, and NE is an engine rotation speed. In addition, a value that is calculated last time and that is stored in the control unit 50 (pulsation coefficient k(i−1)) is used as the pulsation coefficient. The air-fuel ratio fluctuation rate ΔA/F is obtained by detecting an amount of variation in the output of the air-fuel ratio sensor 42 per unit time (or unit crank angle) within one cycle during control for calculating the pulsation coefficient ki.

Amplitude=K×ΔA/F×(1−ê(−{(60/2)/NE}/Sensor Time Constant))×Pulsation Coefficient×Pressure Pulsation (2)

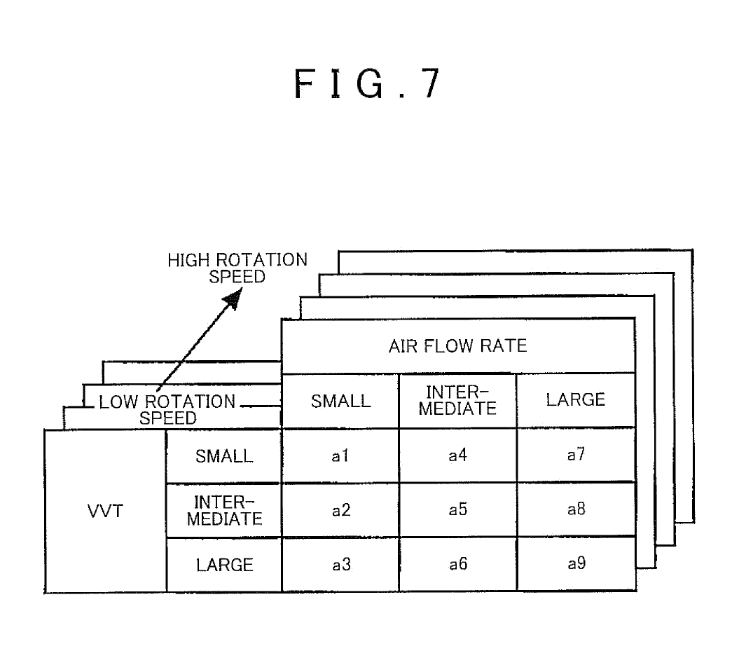

The pressure pulsation correlates with a rotation speed, an air flow rate and valve timing. The valve timing is, for example, controlled by a variable valve timing mechanism (VVT). FIG. 7 is a view for illustrating a map that defines the correlation among a rotation speed, intake air flow rate and valve timing (VVT) of the internal combustion engine and a pressure pulsation. In the first embodiment, as shown in FIG. 7, the correlation between a rotation speed, intake air flow rate and valve timing, and a pressure pulsation is obtained in advance, and the map that defines the correlation is stored in the control unit 50. In actual control, by detecting the rotation speed, the intake air flow rate and the valve timing, the pressure pulsation is obtained. Calculation of Pulsation Coefficient ki

The pulsation coefficient ki at time point i is obtained as a variation in sensor amplitude per unit pressure pulsation. Specifically, as expressed by the following mathematical expression (3), in an environment in which the air-fuel ratio is constant (or there is almost no variation in air-fuel ratio), the pulsation coefficient ki is calculated from the sensor amplitudes at two timings at which pressure pulsations are different, and a difference in pressure pulsation between the timings.

Pulsation Coefficient ki=(Second Amplitude−First Amplitude)/Pulsation Variation Amount (3)

In the above mathematical expression (3), a first amplitude is a sensor amplitude at one detection timing (first detection time point). A second amplitude is a sensor amplitude at detection timing (second detection time point) different from the first detection time point. The first amplitude and the second amplitude are calculated in accordance with the mathematical expression (2) on the basis of various detection values at the respective detection time points.

A pulsation variation amount in the mathematical expression (3) is a difference between the pressure pulsation at the first detection time point and the pressure pulsation at the second detection time point. Each pressure pulsation is calculated through the map described in FIG. 7 on the basis of the rotation speed, intake air flow rate and valve timing at a corresponding one of the first detection time point and the second detection time point. Specifically, when the pressure pulsation at the first detection time point is a9 in FIG. 7 and the pressure pulsation at the second detection time point is a1, the pulsation variation amount is a1-a9.

When there is an imbalance among the cylinders, the influence of the imbalance is included in each of the first amplitude and the second amplitude. However, the first amplitude and the second amplitude are detected in an environment in which the air-fuel ratio is constant (or there is almost no change in air-fuel ratio). Thus, even when there is an imbalance, the imbalance ratio at the time of detecting the first amplitude and the imbalance ratio at the time of detecting the second amplitude are constant, and it is assumed that the amount of increase in amplitude due to the influence of the imbalance, included in each of the sensor output of the first amplitude and the sensor output of the second amplitude is the same or approximate. Thus, the pulsation coefficient ki that is calculated by the above mathematical expression (3) is based on the sensor amplitude from which the influence of the imbalance has been removed to some extent, that is, the pulsation coefficient ki is based on an amount of variation in the output (amplitude) of the air-fuel ratio sensor 42 due to the influence of the pressure pulsation. Calculation of Imbalance Determination Parameter

As described above, when the pressure pulsation is constant, the imbalance ratio and the sensor amplitude have a proportional correlation. Thus, by setting a value obtained by removing an influence due to a fluctuation in pressure pulsation from the sensor amplitude, as an imbalance determination parameter, it is possible to highly accurately determine whether there is an imbalance. Thus, as expressed in the following mathematical expression (4), the imbalance determination parameter is a value obtained by multiplying the sensor amplitude by a reference coefficient and further multiplied by the inverse of the calculated pulsation coefficient ki. The reference coefficient is an initial value k0 of the pulsation coefficient of the air-fuel ratio sensor 42 in an initial state or a value that is set in connection with an imbalance determination threshold (described later).

Determination Parameter=Amplitude×Reference Coefficient/Pulsation Coefficient ki (4)

The sensor amplitude that is a determination value in the mathematical expression (4) is calculated as a difference between the maximum value and minimum value of the sensor output that is detected within one cycle at the time of imbalance determination. Alternatively, the sensor amplitudes in a plurality of cycles may be calculated, and the average of the sensor amplitudes may be set as a determination value. The first and second amplitudes that are calculated by the above mathematical expression (3) are sensor amplitudes based on the sensor outputs detected in a state where the operating conditions at the time of calculating the pulsation coefficient ki are satisfied; whereas the sensor amplitude here is an amplitude of the sensor output detected in actual imbalance detection control.

In the first embodiment, when the imbalance determination parameter calculated as described above is larger than a determination threshold (threshold), it is determined that there is an imbalance. The determination threshold is set to an appropriate value by taking an allowable imbalance ratio, and the like, into consideration in connection with the imbalance determination parameter, and is a value prestored in the control unit 50.

### Detection of Abnormality in Air-fuel Ratio Sensor

The thus calculated pulsation coefficient ki is theoretically a unique value for each air-fuel ratio sensor. However, the pulsation coefficient ki is significantly influenced by a resistance in the diffusion layer 18. If there is a crack in the diffusion layer 18, a resistance in the diffusion layer 18 decreases, so the pulsation coefficient ki increases. On the other hand, for example, when the porosity of an actual diffusion layer has been significantly decreased, such as when the diffusion layer 18 has clogging, the resistance of the diffusion layer 18 increases. Therefore, the pulsation coefficient ki becomes a small value.

Thus, in the first embodiment, when the pulsation coefficient ki does not fall within an allowable range that is set such that a center value coincides with the initial value k0, it is determined that there is an abnormality in the air-fuel ratio sensor 42. Specifically, the upper limit and lower limit of the allowable range (predetermined range), in which the center value coincides with the initial value k0 of the pulsation coefficient ki, are set. When the calculated pulsation coefficient ki is smaller than the lower limit or larger than the upper limit, it is determined that there is an abnormality in the air-fuel ratio sensor 42.

### Imbalance Determination and Detection of Abnormality in Air-fuel Ratio Sensor in First Embodiment

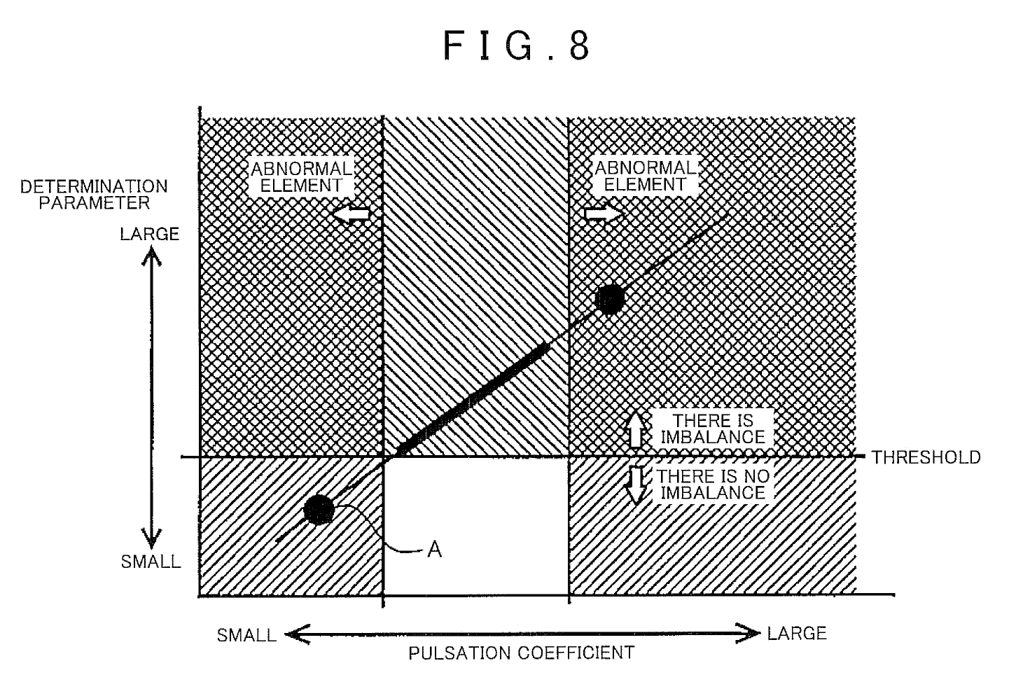

FIG. 8 is a graph for illustrating imbalance determination and detection of an abnormality in the air-fuel ratio sensor 42 in the first embodiment. In FIG. 8, the abscissa axis represents a pulsation coefficient ki, and the ordinate axis represents an imbalance determination parameter. The example shown in FIG. 8 shows an example in which an actual imbalance ratio is 50%.

When the imbalance ratio is 50%, the determination threshold for the imbalance determination parameter is constant irrespective of the pulsation coefficient E as indicated by a threshold line in FIG. 8. In the example shown in FIG. 8, when the imbalance determination parameter is smaller than the determination threshold, it is determined that there is no imbalance; whereas, when the imbalance determination parameter is larger than or equal to the determination threshold, it is determined that there is an imbalance.

However, as shown in FIG. 8, before performing imbalance determination, when the pulsation coefficient ki is smaller than the lower limit or larger than the upper limit, it is determined that there is an abnormality in the air-fuel ratio sensor 42. For example, when the imbalance determination parameter at point A is calculated, it is determined that there is an abnormality in the air-fuel ratio sensor 42, and it is not determined that there is no imbalance. In this way, when there is an imbalance, it is possible to avoid the situation where the erroneous determination that there is no imbalance is made due to an abnormality in the air-fuel ratio sensor 42.

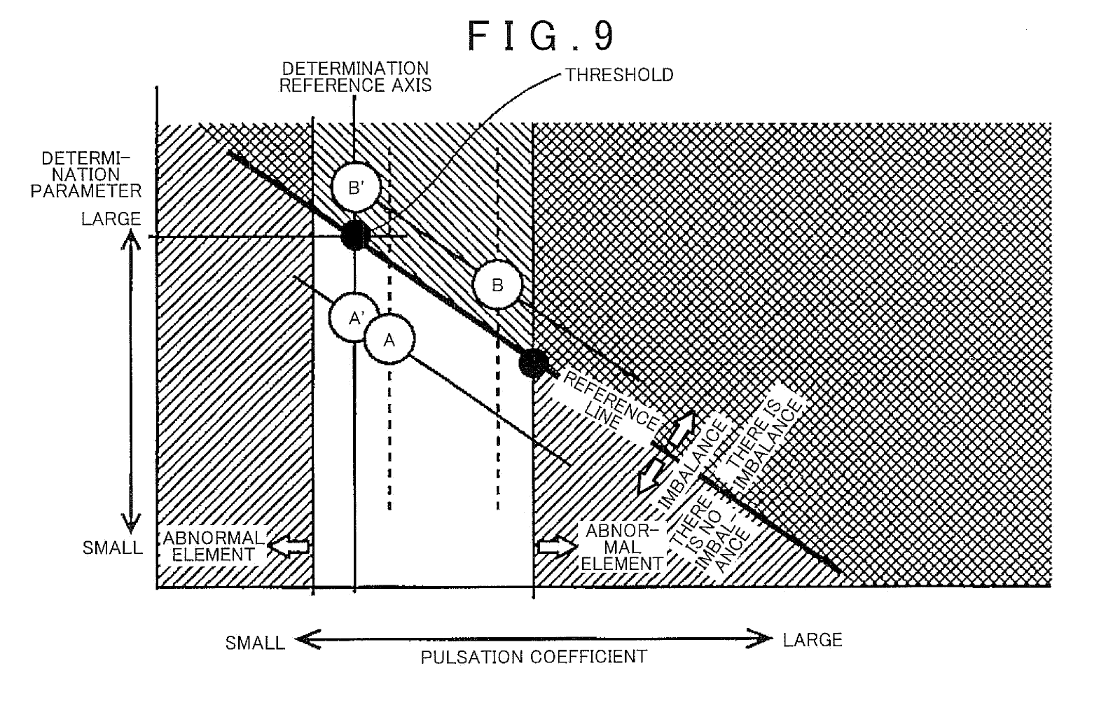

FIG. 9 is a graph for illustrating the correlation between an imbalance determination parameter and a pulsation coefficient ki in the first embodiment. In FIG. 9, the abscissa axis represents a pulsation coefficient ki, and the ordinate axis represents an imbalance determination parameter. In FIG. 9, a region in which the pulsation coefficient ki is smaller than the left-side lower limit and a region in which the pulsation coefficient ki is larger than the right-side upper limit are ranges in which it is determined that there is an abnormality in the air-fuel ratio sensor 42.

In FIG. 9, a reference line indicates the correlation between the pulsation coefficient ki and the imbalance determination parameter at an imbalance ratio at which it should be determined that there is an imbalance. Thus, in FIG. 9, it is determined that there is an imbalance in the case where a point indicated by the calculated pulsation coefficient ki and the imbalance determination parameter is plotted in a region larger than the reference line.

In specific control according to the first embodiment, as expressed by the above mathematical expression (4), the imbalance determination parameter is obtained by correcting the sensor amplitude using the reference coefficient/pulsation coefficient ki. By so doing, for example, when the calculated pulsation coefficient ki and the sensor amplitude are indicated by point A in FIG. 9, a value corrected to point A′ on a determination reference axis (reference axis for determination) is the imbalance determination parameter. Point A′ is smaller than the determination threshold that is the intersection of the reference axis and the reference line. Thus, it is determined that there is no imbalance.

On the other hand, when the calculated pulsation coefficient ki and the sensor amplitude are indicated by point B in the graph, the imbalance determination parameter is a point corrected to point B′ on the reference axis. Point B′ is larger than the determination threshold, so it is determined that there is an imbalance.

### Operating State in which Control according to First Embodiment is Executed

In an environment in which the air-fuel ratio is controlled so as to fall within a reference range that includes a stoichiometric air-fuel ratio and is close to a stoichiometric air-fuel ratio, the sensor output itself decreases, so it may be difficult to highly accurately calculate the pulsation coefficient ki, the imbalance determination parameter, and the like. Thus, in the first embodiment, in order to detect or calculate values in an environment in which the sensor output, and the like, vary by a larger amount, required detection values (engine rotation speed, intake air flow rate, valve timing, and the like) are detected at the following detection timings.

(1) Both the first and second detection time points are timings during fuel cut operation, and the engine rotation speed at the second detection time point is lower than the engine rotation speed at the first detection time point. (2) Both the first and second detection time points are timings that are not during feedback control, the air-fuel ratio at the first detection time point is the same as the air-fuel ratio at the second detection time point, and the pressure pulsation at the second detection time point significantly differs from the pressure pulsation at the first detection time point. (3) Both the first and second detection time points are timings during feedback control, the air-fuel ratio at the first detection time point is the same as the air-fuel ratio at the second detection time point, the air-fuel ratio at the first and second detection time points deviates toward any one of a rich side and a lean side, and the pressure pulsation at the second detection time point significantly differs from the pressure pulsation at the first detection time point. (4) When feedback control is being executed within the reference range including the stoichiometric air-fuel ratio (hereinafter, during stoichiometric air-fuel ratio operation), the air-fuel ratio is set to a certain rich-side or lean-side target value outside the reference range, and, furthermore, the valve timing is controlled so as to forcibly fluctuate the pressure pulsation. The first and second detection time points are set to timings during this control.

### Routine of Specific Control of First Embodiment

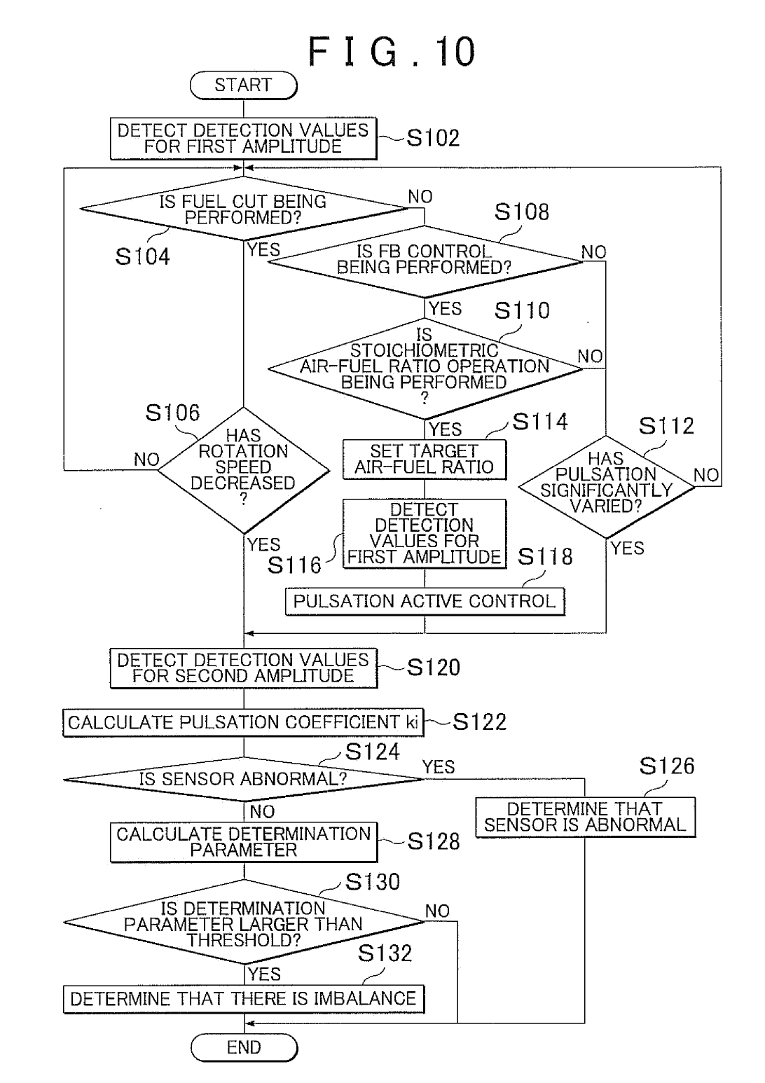

FIG. 10 is a flowchart for illustrating the routine of control that is executed by the control unit 50 in the first embodiment of the invention. The routine shown in FIG. 10 is a routine that is repeatedly executed at constant intervals during operation of the internal combustion engine. In the routine shown in FIG. 10, first, detection values required to calculate the first amplitude are detected (S102). Specifically, detection values required to calculate the first amplitude through the above-described mathematical expression (2), for example, a current rotation speed of the internal combustion engine, current valve timing, a current intake air flow rate, a pressure pulsation estimated from these values, and the like, are detected.

Subsequently, it is determined whether an operating state from the first detection time point in step S102 to current time point is a fuel cut operation state (S104). When fuel cut operation is being performed, it is determined whether the engine rotation speed has been sufficiently decreased from the first detection time point (S106). Here, determination as to whether the engine rotation speed has been sufficiently decreased is made, for example, on the basis of whether a difference between the engine rotation speed at the first detection time point and the engine rotation speed at the current rotation speed is larger than a preset reference value. When it is determined that the engine rotation speed has not been sufficiently decreased, the process is returned to step S104. On the other hand, when it is determined that the engine rotation speed has been sufficiently decreased, the process proceeds to step S120.

When it is determined in step S104 that fuel cut operation is not being performed, it is subsequently determined whether the operating state of the internal combustion engine at each of the first detection time point in step S102 and the current time point is a feedback (FB) control state (i.e., whether the feedback control is being performed) (S108).

When it is determined in step S108 that the operating state is a feedback control state (i.e., the feedback control is being performed), it is subsequently determined whether the operating state of the internal combustion engine at each of the first detection time point and the current time point is a stoichiometric air-fuel ratio operation state (i.e., whether the stoichiometric air-fuel ratio operation is being performed) (S110). Here, determination as to whether the operating state is the stoichiometric air-fuel ratio operation state is made, for example, on the basis of whether a target air-fuel ratio falls within a predetermined range that includes the stoichiometric air-fuel ratio.

When it is determined in step S108 that the operating state is not the feedback control state (i.e., the feedback control is not being performed) or when it is determined in step S110 that the operating state is not the stoichiometric air-fuel ratio operation state (i.e., the stoichiometric air-fuel ratio operation is not being performed), it is subsequently determined whether the pressure pulsation has significantly varied from that at the first detection time point in step S102 (S112). Determination as to whether the pressure pulsation has significantly varied is made, for example, on the basis of whether the engine rotation speed, the intake air flow rate and/or the valve timing significantly vary between the first detection time point and the current time point. In step S112, when it is determined that the pressure pulsation has not significantly varied, the process is returned to step S104. On the other hand, when it is determined that the pressure pulsation has significantly varied, the process proceeds to step S120.

In addition, when it is determined in step S108 that the operating state is the feedback control state and it is determined in step S110 that the operating state is the stoichiometric air-fuel ratio operation state, the target air-fuel ratio in air-fuel ratio feedback control is subsequently set to a predetermined rich side or lean side value that falls outside the reference range, and the air-fuel ratio is controlled to this rich or lean target air-fuel ratio (S114).

After that, the detection values for the first amplitude are detected again (S116). Subsequently, pulsation active control is executed (S118). Here, in a state where air-fuel ratio feedback control is being performed and the air-fuel ratio is kept at the target air-fuel ratio set in step S114, the valve timing is controlled at predetermined timing such that the pressure pulsation significantly varies. After that, the process proceeds to step S120.

In step S120, detection values for calculating the second amplitude are detected. Specifically, the engine rotation speed, the intake air flow rate, the valve timing, the pressure pulsation estimated from these, and the like, are detected.

Subsequently, the pulsation coefficient ki is calculated (S122). The pulsation coefficient ki is computed in accordance with the above mathematical expression (3) on the basis of the first amplitude detected in step S102, the second amplitude detected in step S120, the pressure pulsation at the first detection time point and the pressure pulsation at the second detection time point.

Subsequently, it is determined whether there is an abnormality in the air-fuel ratio sensor 42 (S124). Specifically, it is determined whether the pulsation coefficient ki computed in step S122 is smaller than the lower limit or larger than the upper limit, and, when the pulsation coefficient ki is smaller than the lower limit or larger than the upper limit, it is determined that there is an abnormality in the air-fuel ratio sensor 42. The upper limit and the lower limit are preset for an adequate range including the initial value k0 of the pulsation coefficient as described above, and are stored in the control unit 50.

When it is determined in step S124 that there is an abnormality in the air-fuel ratio sensor 42 (i.e., an affirmative determination is made in step S124), the determination that there is an abnormality in the air-fuel ratio sensor 42 is made (S126), and a predetermined process at the time of an abnormality, for example, a process of turning on an alarm lamp, such as an MIL, is executed, after which the current process ends.

On the other hand, when it is determined in step S124 that there is not an abnormality in the air-fuel ratio sensor 42 (i.e., a negative determination is made in step S124), the imbalance determination parameter is subsequently calculated (S128). In calculating the imbalance determination parameter, first, the sensor amplitude is obtained by subtracting the minimum value of the sensor output in a period from a start of control to the current time point, from the maximum value of the sensor output in the period. The imbalance determination parameter is calculated in accordance with the mathematical expression (4) on the basis of the sensor amplitude, the reference coefficient and the pulsation coefficient ki computed in step S122.

Subsequently, it is determined whether the imbalance determination parameter calculated in step S128 is larger than the determination threshold (S130). The determination threshold is determined in consideration of an allowable imbalance ratio, and the like, and is stored in the control unit 50 in advance.

When it is determined in step S130 that the imbalance determination parameter is larger than the determination threshold, it is determined that there is an imbalance (S132), and a predetermined process that should be executed at the time when there is an imbalance is executed, after which the current process ends.

On the other hand, when it is determined in step S130 that the imbalance determination parameter is equal to or smaller than the determination threshold, it is determined that there is no imbalance, so the current process ends.

As described above, in the first embodiment, it is possible to detect an abnormality in the air-fuel ratio sensor 42 and to determine whether there is an imbalance among the cylinders, in consideration of an influence due to the pressure pulsation. Thus, it is possible to further highly accurately determine whether there is an abnormality in the air-fuel ratio sensor 42 and to determine whether there is an imbalance through the determination parameter based on the sensor output from which the influence of a variation in the pressure pulsation has been removed. Thus, it is possible to prevent erroneous determination due to the abnormal air-fuel ratio sensor 42 and to improve the accuracy of imbalance determination.

### Another Example of Control of First Embodiment

In the first embodiment, the description is made on the case where the sensor output is corrected by the pulsation coefficient ki. However, according to the invention, a target to be corrected using the pulsation coefficient ki is not limited to the sensor output, and, for example, the determination threshold may be corrected using the pulsation coefficient ki. In this case, for example, in the example shown in FIG. 9, the determination threshold is corrected by multiplying the determination threshold by the pulsation coefficient ki and a predetermined coefficient such that the determination threshold is a point on the reference line. Then, the sensor amplitude is compared with the determination threshold corrected using the pulsation coefficient ki. By correcting the determination threshold in this way as well, similarly, it is possible to highly accurately make imbalance determination by removing a pulsation influence.

In addition, in the first embodiment, the description is made on the case where the sensor amplitude is used as a determination value for imbalance determination. However, the invention is not limited to this configuration; another determination value that correlates with an imbalance ratio may be used. Specifically, for example, the imbalance ratio correlates with the rate of variation in output of the air-fuel ratio sensor 42 per unit crank angle. The rate of variation in output of the air-fuel ratio sensor 42 receives a pulsation influence. Thus, when the rate of variation in output is used as a determination value as well, by correcting the rate of variation in output such that a pulsation influence is removed using the pulsation coefficient ki, it is possible to further accurately determine whether there is an imbalance. Also, the determination threshold for the rate of variation in output may be corrected using the pulsation coefficient ki. The determination value for imbalance determination is not limited to the sensor amplitude or the rate of variation in the output of the air-fuel ratio sensor 42. Another determination value calculated on the basis of a variation in sensor output may be employed.

In addition, the description is made on the case where the pulsation coefficient ki is obtained by the mathematical expression (3). However, according to the invention, a method of calculating the pulsation coefficient ki is not limited to this configuration. Even when the first amplitude and the second amplitude each include an influence due to an imbalance, the pulsation coefficient ki just needs to be set on the basis of a difference between the first amplitude and the second amplitude such that these imbalances are excluded. Thus, the pulsation coefficient ki may be set as the ratio of a difference between the first amplitude and the second amplitude with respect to the first amplitude or the second amplitude as in the case of the following mathematical expression (5) or mathematical expression (6).

Pulsation Coefficient ki=(Second Amplitude−First Amplitude)/(Pulsation Variation Amount×First Amplitude) (5)

Pulsation Coefficient ki=(Second Amplitude−First Amplitude)/(Pulsation Variation Amount×Second Amplitude) (6)

Alternatively, the pulsation coefficient ki may be set as the ratio between the first amplitude and the second amplitude as in the case of the following mathematical expression (7) or mathematical expression (8).

Pulsation Coefficient ki=(Second Amplitude/First Amplitude)/Pulsation Variation Amount (7)

Pulsation Coefficient Ki=(First Amplitude/Second Amplitude)/Pulsation Variation Amount (8)

In the first embodiment, the description is made on the case where detecting an abnormality in the air-fuel ratio sensor 42 and making imbalance determination are performed at the same time. However, the invention is not limited to this configuration. Only detecting an abnormality in the air-fuel ratio sensor 42 may be performed using the pulsation coefficient ld. Alternatively, only determination as to whether there is an imbalance may be made without detecting an abnormality in the air-fuel ratio sensor 42. Even when detecting an abnormality in the air-fuel ratio sensor 42 is not performed in this way, by making determination as to whether there is an imbalance after correction using the pulsation coefficient ki, it is possible to improve the accuracy of imbalance determination.

In the first embodiment, the description is made on the case where imbalance determination and detection of an abnormality in the air-fuel ratio sensor 42 are performed during operation of any one of the above (1) to (4). However, the invention is not limited to this configuration. Imbalance determination or detection of an abnormality in the air-fuel ratio sensor 42 may be performed in another operation environment.

### Second Embodiment

A system and an air-fuel ratio sensor according to a second embodiment respectively have the same configurations as the system and the air-fuel ratio sensor 42 shown in FIG. 1, FIG. 2A and FIG. 2B. In the first embodiment, the description is made on the case where the pulsation coefficient ki is obtained on the basis of the first amplitude, the second amplitude and the amount of variation in the pressure pulsation, the determination value is corrected using the pulsation coefficient ki and then imbalance determination is made on the basis of the imbalance determination parameter that is the corrected determination value.

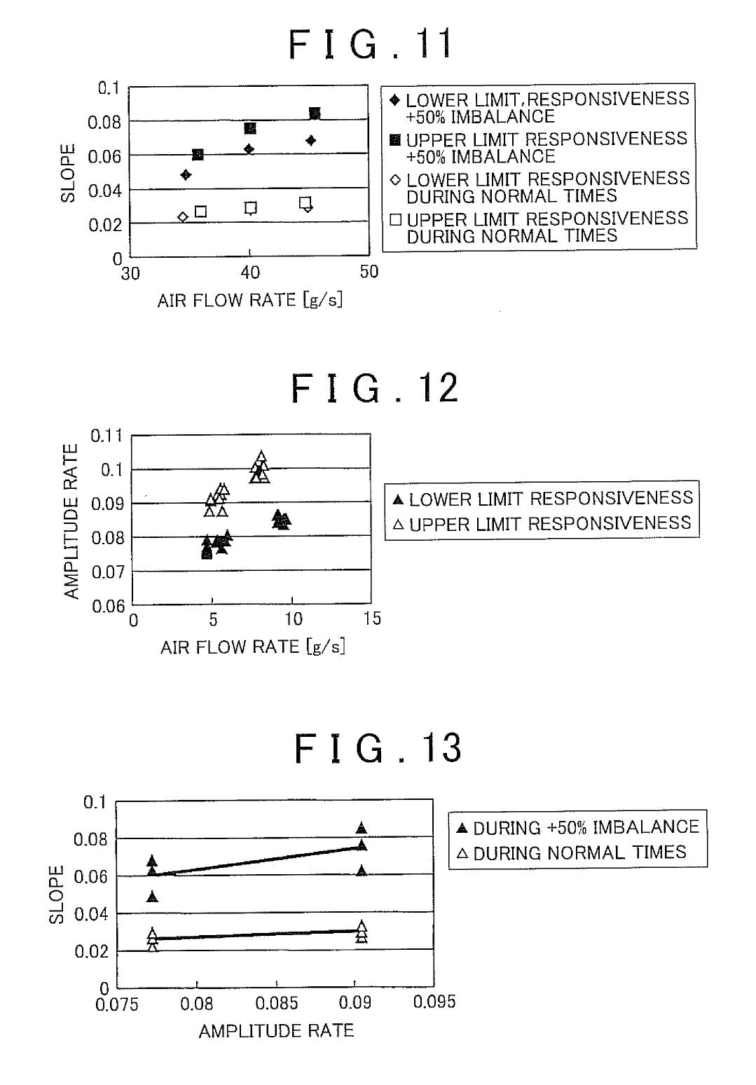

In contrast to this, in the second embodiment, description will be made on the case where an amount of variation in sensor output (output variation amount) due to the influence of the pressure pulsation is obtained from an amplitude rate during fuel cut operation (hereinafter, also referred to as “FC”) (hereinafter, an amplitude rate during FC may also be referred to as “FC amplitude rate”). FIG. 11 is a graph for illustrating the correlation between an intake air flow rate of the internal combustion engine and a slope of the sensor output. In FIG. 11, the abscissa axis represents an intake air flow rate, and the ordinate axis represents a slope of the sensor output.

It is evident from FIG. 11 that, when there is an imbalance, the slope of the sensor output (hereinafter, also referred to as “output slope”) during one combustion cycle of the internal combustion engine increases. The imbalance ratio and the output slope correlate with each other. The responsiveness of the air-fuel ratio sensor has a tolerance to a certain extent. As described above, when the responsiveness of the air-fuel ratio sensor varies, the influence of the pressure pulsation varies, and the influence of the pressure pulsation increases as the responsiveness increases. Thus, as shown in FIG. 11, the air-fuel ratio sensor whose responsiveness is a lower limit of a tolerance (i.e., whose responsiveness is slow) has a small output slope, and the air-fuel ratio sensor whose responsiveness is an upper limit of a tolerance (i.e., whose responsiveness is quick) has a large output slope. This tendency is more remarkable when there is an imbalance. Particularly, a difference between the output slope in the case where the responsiveness is an upper limit and there is no imbalance (during normal times) and the output slope in the case where the responsiveness is a lower limit and there is an imbalance becomes small. Thus, when it is determined whether there is an imbalance on the basis of the output slope during one cycle, it is required to remove the influence of the pressure pulsation, which varies depending on the responsiveness.

FIG. 12 is a graph for illustrating the correlation between an intake air flow rate and an FC amplitude rate during FC. In FIG. 12, the abscissa axis represents an intake air flow rate, and the ordinate axis represents an FC amplitude rate. It is assumed that the FC amplitude rate means the ratio of the amplitude of the sensor output to an output average. During FC of the internal combustion engine, the air-fuel ratio of exhaust gas is a constant value corresponding to atmosphere. Thus, even if there is an imbalance, the sensor output does not receive the influence of the imbalance. Thus, it is presumable that a variation in output during FC is due to the pressure pulsation. That is, it is presumable that a difference in responsiveness of the sensor element 10 during the cycle (that is, a difference in pulsation influence during the cycle), from which the influence of an imbalance is excluded, appears in the FC amplitude rate that is a sensor output variation amount during FC. Specifically, as shown in FIG. 12, the FC amplitude rate increases as the cycle responsiveness of the air-fuel ratio sensor is quicker, and the FC amplitude rate decreases as the cycle responsiveness of the sensor is slower.

FIG. 13 shows the correlation between an FC amplitude rate and an output slope. In FIG. 13, the abscissa axis represents an FC amplitude rate, and the ordinate axis represents an output slope. As shown in FIG. 13, the output slope and the FC amplitude rate correlate with each other. In the second embodiment, correction for removing the influence of the FC amplitude rate from the output slope is made on the basis of this correlation. It is presumable that a difference in pulsation influence has been removed from the corrected output slope, and it is possible to determine whether there is an imbalance on the basis of the corrected output slope.

FIG. 14 shows the correlation between an FC amplitude rate and a correction coefficient for an output slope in the second embodiment of the invention. It is possible to obtain the correlation between an FC amplitude rate and a correction coefficient, shown in FIG. 14, on the basis of the correlation between an FC amplitude rate and an output slope during normal times, shown in FIG. 13. The obtained correlation between an FC amplitude rate and a correction coefficient is set by a mathematical expression, a map, or the like, in advance, and is stored in the control unit 50.

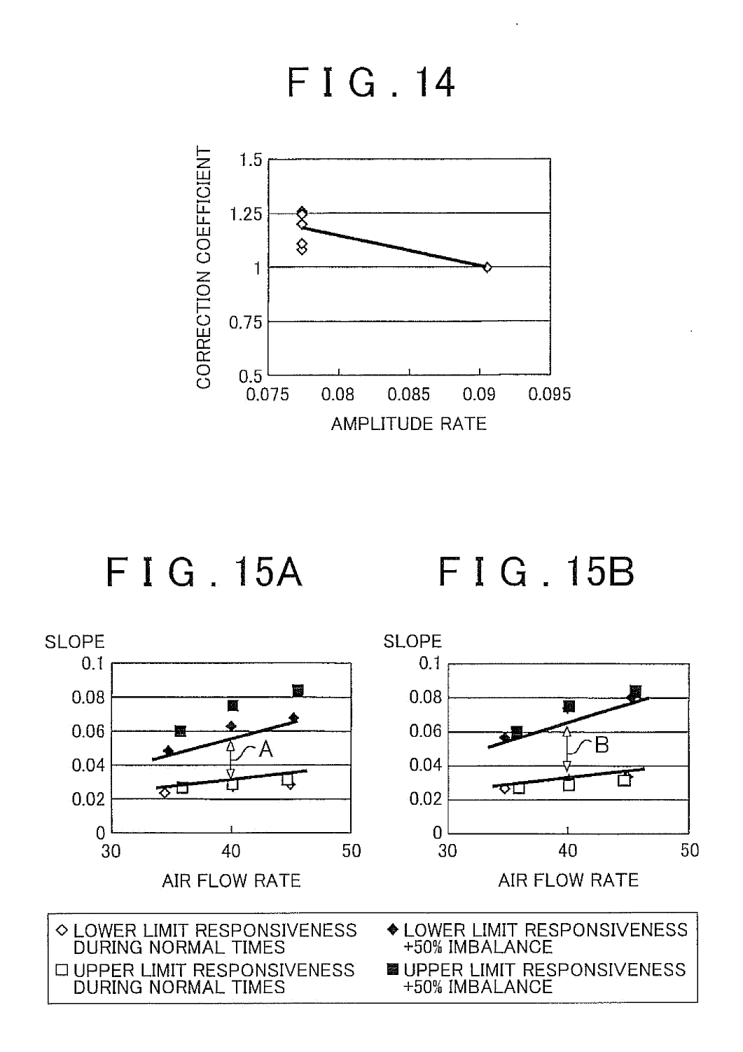

FIG. 15A and FIG. 15B are graphs for illustrating a variation in output slope with respect to an air flow rate. FIG. 15A shows an uncorrected output slope. FIG. 15B shows an output slope corrected by a correction coefficient. In each of FIG. 15A and FIG. 15B, the abscissa axis represents an intake air flow rate, and the ordinate axis represents an output slope. When FIG. 15A is compared with FIG. 15B, B is increased with respect to A. That is, by correcting the output slope using the correction coefficient based on the FC amplitude rate, the influence of a difference in responsiveness on an output slope is excluded, so a difference between an output slope during normal times and an output slope at the time when there is an imbalance increases. Thus, it is possible to improve the accuracy of detecting whether there is an imbalance.

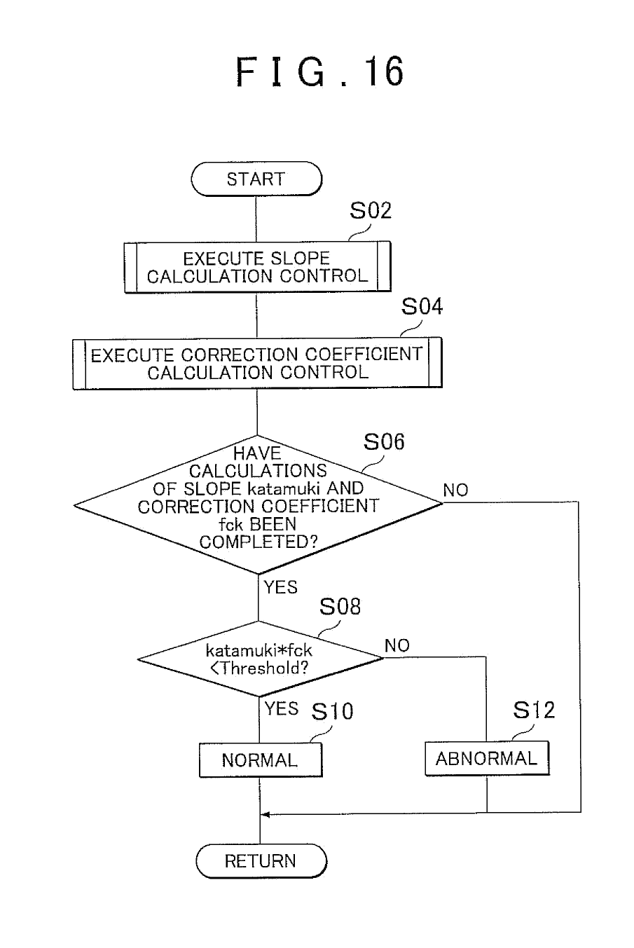

FIG. 16 to FIG. 19 are flowcharts for illustrating the routines of controls that are executed by the control unit 50 in the second embodiment of the invention. The routine shown in FIG. 16 is repeatedly executed at constant intervals (for example, about 1 ms to 4 ms). In the routine shown in FIG. 16, first, slope calculation control is executed (S02). The slope calculation control is control for calculating an output slope katamuki. The details of the routine of the slope calculation control will be described later.

Subsequently, correction coefficient calculation control is executed (S04). The correction coefficient calculation control is control for calculating a correction coefficient fck based on an FC amplitude rate. The details of the routine of the correction coefficient calculation control will be described later.

Subsequently, it is determined whether calculation of the output slope katamuki has been completed and calculation of the correction coefficient fck has been completed (S06). When it is determined that at least one of calculation of the output slope katamuki and calculation of the correction coefficient fck has not been completed, the current process ends.

On the other band, when it is determined that calculation of the output slope katamuki and calculation of the correction coefficient fck have been completed in step S06, it is subsequently determined whether a corrected value katamuki*fck of the output slope katamuki, which is obtained by correction using the correction coefficient fck, is smaller than a threshold Threshold (S08). Here, the threshold Threshold is appropriately set in advance by, for example, taking into consideration the output slope of the air-fuel ratio sensor whose responsiveness is an upper limit of the tolerance during normal times, and, in this control, a value prestored in the control unit 50 is used.

When it is determined in step S08 that the corrected output slope katamuki*fck is smaller than the threshold Threshold, it is determined that the state is normal (that is, there is no air-fuel ratio variation among the cylinders, in other words, there is no inter-cylinder air-fuel ratio imbalance) (S10). On the other hand, when it is determined that the corrected output slope katamuki*fck is equal to or larger than the threshold Threshold, it is determined that the state is abnormal, that is, it is determined that there is an imbalance (i.e., an inter-cylinder air-fuel ratio imbalance) (S12). After the determination process of step S10 or step S12, the current process ends.

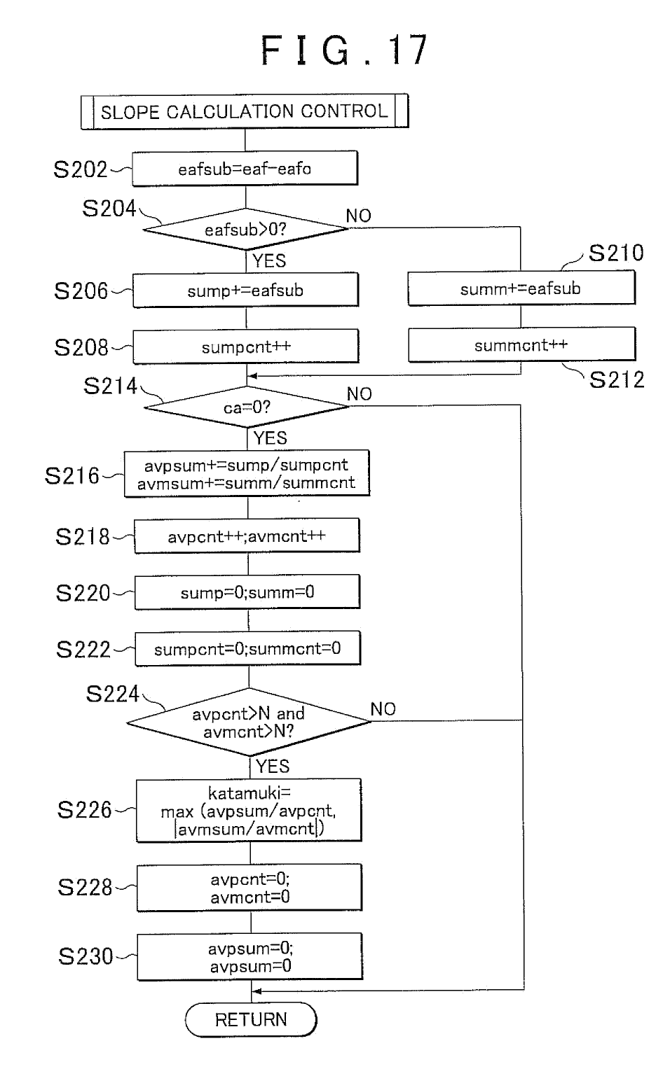

Next, the slope calculation control routine will be described with reference to FIG. 17. When the slope calculation control is started, first, a difference between an air-fuel ratio eaf0 at the time when the routine is executed last time and a current air-fuel ratio ef0, that is, an output slope eafsub, is calculated (S202). Subsequently, it is determined whether the output slope eafsub is larger than zero (S204).

When it is identified in step S204 that the output slope eafsub is larger than zero, the calculated output slope eafsub is accumulated into a positive slope accumulated value sump (S206). After that, a positive slope accumulation number sumpcnt is incremented by one (S208). On the other hand, when it is determined that the output slope eafsub is equal to or smaller than zero, the calculated output slope eafsub is accumulated into a negative slope accumulated value summ (S210). After that, a negative slope accumulation number summcnt is incremented (S212). Each of the accumulation numbers sumpcnt and summcnt is a counter that is set at zero as an initial value and that counts the number of accumulation of the output slope eafsub by adding one in each accumulation process of step S206 or step S210.

After the process of step S208 or step S212, it is subsequently determined whether the crank angle CA is zero (S214). The crank angle CA is detected on the basis of the output of the crank angle sensor 4. When it is determined that the crank angle CA is not zero, it is determined that the current timing is not the timing at which the output slope should be calculated (i.e., the output slope should not be calculated at the current timing). Thus, the current process ends.

On the other hand, when it is determined that the crank angle CA is zero in step S214, it is determined that the current timing is the timing at which the output slope should be calculated. In this case, the process proceeds to step S216, the average sump/sumpcnt of the positive slope accumulated value sump is accumulated into a positive slope average accumulated value avpsum, and the average summ/summcnt of the negative slope accumulated value summ is accumulated into a negative slope average accumulated value avmsum (S216).

Through the determination process of S214, during one cycle from when the crank angle CA is zero to when the crank angle CA becomes zero again, the output slope is accumulated, and the average of the slope accumulated value, is calculated for each one cycle.

Subsequently, each of a positive slope average accumulation number avpcnt and a negative slope average accumulation number avmcnt is incremented (S218). The accumulation numbers avpcnt and avmcnt are counters that are set at zero as an initial value and that respectively count the numbers of accumulation of the corresponding average accumulated values avpsum and avmsum by respectively adding one to the avpcnt and avmcnt in each accumulation process of step S216.

Subsequently, each of the positive slope accumulated value sump and the negative slope accumulated value summ is initialized and is set to zero (S220). Subsequently, each of the positive slope accumulation number sumpcnt and the negative slope accumulation number summcnt is initialized and is set to zero (S222).

Subsequently, it is determined whether the positive slope average accumulation number avpcnt and the negative slope average accumulation number avmcnt are both larger than a predetermined number N (i.e., whether a condition that the positive slope average accumulation number avpcnt and the negative slope average accumulation number avmcnt are both larger than a predetermined number N is satisfied) (S224). When it is determined in step S224 that the, condition that the accumulation numbers avpcnt and avmcnt are both larger than the predetermined number N is not satisfied, the current process ends.

On the other hand, when it is determined in step S224 that the accumulation numbers avpcnt and avmcnt are both larger than the predetermined number N, the output slope katamuki is subsequently calculated (S226). Specifically, the average avpsum/avpcnt obtained by dividing the positive slope average accumulated value avpsum by the accumulation number avpcnt and the absolute value |avmsum/avmcnt| of the average avmsum/avmcnt obtained by dividing the negative slope average accumulated value avmsum by the accumulation number avmcnt are calculated, and the larger one is set as the output slope katamuki.

After that, the accumulation numbers avpcnt and avmcnt are initialized and set to zero (S228). In addition, the slope average accumulated values avpsum and avmsum are set to zero and initialized (S230). After that, the slope calculation control ends.

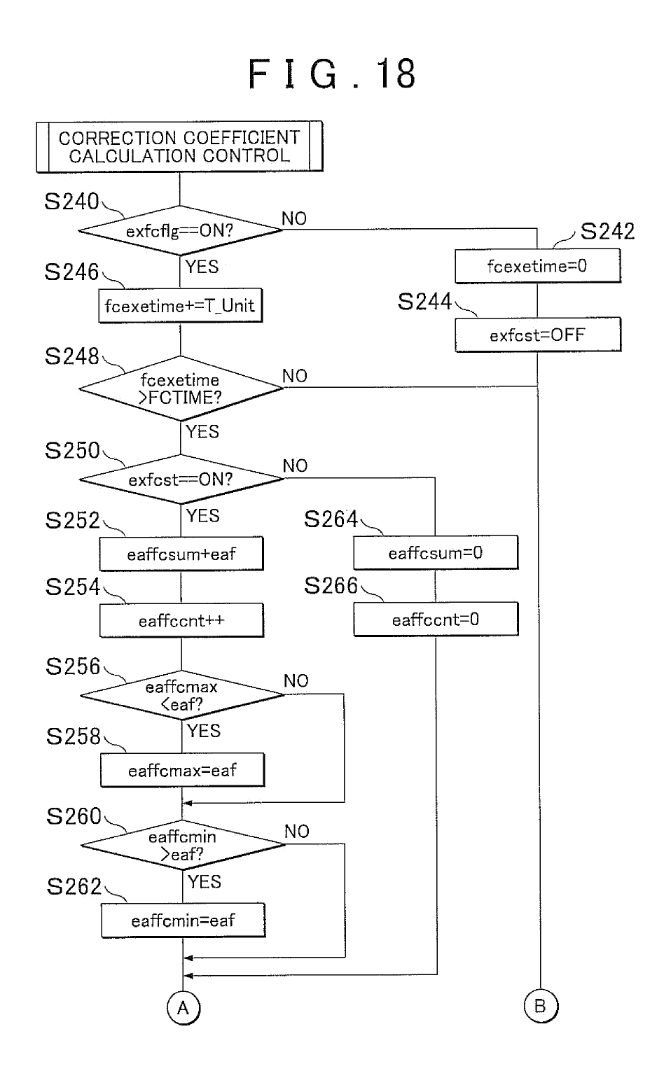

Next, the routine of the correction coefficient calculation control will be described with reference to FIG. 18. When the routine of the correction coefficient calculation control, shown in FIG. 18, is started, first, it is determined whether an FC execution flag exfcflg is in an on state (S240). The FC execution flag exfcflg is a flag that is set to an on state during FC control, and the on/off states of the FC execution flag exfcfig are controlled by a separately set routine of FC control.

When it is determined in step S240 that the FC execution flag exfcflg is not in an on state (i.e., the FC execution flag exfcflg is in an off state), the current environment is not an environment in which the correction coefficient fck should be calculated, so a time counter fcexetime that measures the duration of FC control is set to zero (S242), and a permission flag exfcst is set to an off state (S244). After that, the current process ends. The permission flag exfcst is set to an on state when the duration of FC control is longer than a predetermined period of time through the process of step S284 (described later), and is set to an off state through the process of step S244 when FC is not being performed.

On the other hand, when it is determined in step S240 that the FC execution flag exfcflg is in an on state, an FC execution time T_Unit is subsequently added to the time counter fcexetime (S246). The FC execution time T_Unit is an elapsed time from when the FC execution time T_Unit is added to the time counter fcexetime through the process of step S246 last time, to when the process of S246 is executed again after the correction coefficient calculation control routine is started.

Subsequently, it is determined whether the time counter fcexetime is longer than a predetermined time FCTIME (S248). Here, the predetermined time FCTIME is appropriately set on the basis of, for example, a duration of FC operation that is presumed to be necessary and sufficient to stably calculate the correction coefficient, and the predetermined time FCTIME is stored in the control unit 50. When it is determined in step S248 that the time counter fcexetime is equal to or shorter than the predetermined time FCTIME, the current process ends.

On the other hand, when it is determined in step S248 that the time counter fcexetime is longer than the predetermined time FCTIME, it is subsequently determined whether the permission flag exfcst is in an on state (S250). When it is determined in step S250 that the permission flag exfcst is not in an on state (i.e., the permission flag exfcst is in an off state), an output accumulated value eaffcsum and an output accumulated value accumulation number eaffccnt in this cycle are both set to zero and initialized (S264 and S266).

On the other hand, when it is determined in step S250 that the permission flag exfcst is in an on state, the sensor output eaf is subsequently added to the output accumulated value eaffcsum up to the current time point (S252). Subsequently, the accumulation number eaffccnt of the output accumulated value eaffcsum is incremented by one (S254). The accumulation number eaffccnt is a counter that is set to zero as an initial value and that counts the number of accumulation of the output accumulated value eaffcsum by adding one in each accumulation process of step S252.

Subsequently, it is determined whether the current output eaf is larger than the maximum output eaffcmax during FC in this cycle (S256). When it is determined that the current output eaf is larger than the maximum output eaffcmax, the current output eaf is set as the maximum output eaffcmax (S258).

When it is determined in step S256 that the current output eaf is equal to or smaller than the maximum output eaffcmax or after the maximum output eaffcmax is updated in step S258, it is subsequently determined whether the current output eaf is smaller than a minimum output eaffcmin (S260). When it is determined that the current output eaf is smaller than the minimum output eaffcmin, the current output eaf is set as the minimum output eaffcmin (S262).

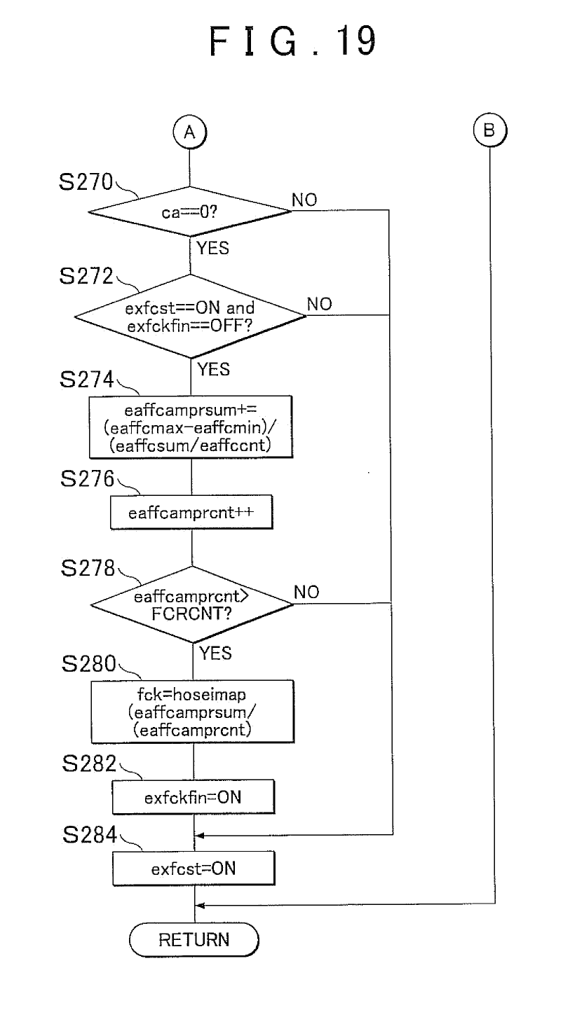

When it is determined in step S260 that the current output eaf is equal to or larger than the minimum output eaffcmin, when the minimum output eaffcmin is updated in step S262 or when the accumulation number eaffccnt is set to zero in step S266, the process subsequently proceeds to step S270 of the routine shown in FIG. 19, and it is determined whether the crank angle CA is zero.

When it is determined in step S270 that the crank angle CA is zero, it is subsequently determined whether the permission flag exfcst is in an on state and a completion flag exfckfin is in an off state (i.e., whether a condition that the permission flag exfcst is in an on state and the completion flag exfckfin is in an off state is satisfied) (S272). The completion flag exfckfin is set to an on state through the process of step S282 (described later) when calculation of the correction coefficient has been completed. When it is determined in step S272 that the permission flag exfcst is in an on state and the completion flag exfckfin is in an off state (i.e., the condition that the permission flag exfcst is in an on state and the completion flag exfckfin is in an off state is satisfied), it is determined that the correction coefficient is currently being calculated. Thus, subsequently, in step S274, the FC amplitude rate in the current cycle is accumulated into an FC amplitude rate accumulated value eaffcamprsum. The FC amplitude rate in the current cycle is a value that is obtained by dividing a difference (eaffcmax−eaffcmin) between the maximum output eaffcmax and the minimum output eaffcmin by the output average (eaffcsum/eaffccnt). After that, a counter eaffcamprcnt for the accumulation number of the FC amplitude rate accumulated value eaffcamprsum is incremented (S276).

Subsequently, it is determined whether the accumulation number eaffcamprcnt of the current FC amplitude rate is larger than a predetermined number FCRCNT (S278). Here, the predetermined number FCRCNT is the number of times, which is necessary and sufficient for further accurately detecting the FC amplitude rate, and the predetermined number FCRCNT is appropriately set.

When it is determined in step S278 that the accumulation number eaffcamprcnt is larger than the predetermined number, the correction coefficient fck is subsequently calculated in step S280. The correction coefficient fck is calculated using a map, on the basis of the calculated average (eaffcamprsum/eaffcamprcut) of the amplitude rate accumulated value.

Subsequently, the completion flag exfckfin is set to an on state (S282). By so doing, completion of calculation of the current correction coefficient is indicated. After the completion flag exfckfin is set to an on state, when it is determined in step S270 that the crank angle CA is not zero yet, when at least any one of the fact that the permission flag exfcst is in an on state and the fact that the completion flag exfckfm is in an off state is not identified in step S272 (i.e., when the condition that the permission flag exfcst is in an on state and the completion flag exfckfin is in an off state is not satisfied in step S272), or when it is determined in step S278 that the FC amplitude rate accumulation number eaffcamprcnt is equal to or smaller than the predetermined number FCRCN, the FC amplitude rate for calculating the correction coefficient should continue to be detected, so the permission flag exfcst is set to an on state (S284), after which the current process ends.

As described above, according to the second embodiment, by using the output slope katamuki corrected by the correction coefficient fck corresponding to the FC amplitude rate, as a determination parameter, it is possible to further highly accurately determine a variation in air-fuel ratio.

The description is made on the case where the average of the accumulated values detected multiple times is used in calculating the output slope katamuki and calculating the FC amplitude rate. However, the invention is not limited to the configuration using such an average. The calculated output slope just needs to be corrected on the basis of the FC amplitude rate. When an average is used as well, the control routine for calculating the average is not limited to the configuration described in FIG. 17 to FIG. 19. This also applies to the following embodiments.

In the second embodiment, the description is made on the case where a value obtained by correcting the calculated output slope using the correction coefficient fck is used as a determination parameter. However, the invention is not limited to this configuration. For example, the threshold Threshold that is a determination reference value may be corrected on the basis of the FC amplitude rate. In addition, imbalance determination may be made by correcting both the output slope and the threshold on the basis of the FC amplitude rate. This also applies to the following embodiments.

In the slope calculation control routine, one of the average of the positive slopes and the average of the negative slopes, which is larger than the other, is used as the output slope katamuki; however, the invention is not limited to this configuration. Specifically, the output slope may be the sum of the average of the positive slopes and the average of the negative slopes or the maximum values of the positive and negative slopes may be used as a slope. Thus, it is possible to appropriately set a method of calculating an output slope such that the output slope correlates with an air-fuel ratio variation. The description is made on the case where the output slope is used as a parameter for imbalance determination. However, the invention is not limited to this configuration. As long as a parameter is based on an amount of variation in sensor output in one combustion cycle, any parameter may be used. Specifically, for example, the rate of variation in sensor output per unit crank angle, the sensor amplitude in one cycle, and the like, correlate with an imbalance ratio, so these may be used as a determination parameter. In addition, the rate of variation in sensor output and the sensor amplitude in one cycle receive the influence of the pressure pulsation. Thus, by obtaining the correlation between a determination parameter and an FC amplitude rate in advance and correcting the parameter or determination reference value for the parameter on the basis of the FC amplitude rate, it is possible to make imbalance determination by excluding the influence of the pressure pulsation. This also applies to the following embodiments.

In the second embodiment, the description is made on the case where the FC amplitude rate is obtained from the average output, maximum output and minimum output of the air-fuel ratio during the cycle. However, the invention is not limited to this configuration. For example, the correction coefficient may be obtained through correction based on an amplitude (maximum output−minimum output). This also applies to the following embodiments.

In the second embodiment, the description is made on the case where control for detecting an abnormality in the air-fuel ratio sensor is not included. However, the invention is not limited to this configuration. Detection of an abnormality in the air-fuel ratio sensor, described in the first embodiment, may be performed in combination. As described in the first embodiment, when there is a crack in the diffusion layer 18, a resistance in the diffusion layer 18 decreases, so the FC amplitude rate increases; whereas, for example, when the porosity of an actual diffusion layer has been significantly decreased, such as when the diffusion layer 18 has clogging, the resistance of the diffusion layer 18 increases. Therefore, the FC amplitude rate becomes a small value. Thus, for example, in the second embodiment, when the FC amplitude rate that is calculated as an output variation amount does not fall within an allowable range that is set such that the center value coincides with the initial value (value in the case of a normal state), it may be determined that there is an abnormality in the air-fuel ratio sensor 42. This also applies to the following embodiments.

### Third Embodiment

A system and the air-fuel ratio sensor 42 according to the third embodiment respectively have the same configurations as those described in FIG. 1, FIG. 2A and FIG. 2B. The system according to the third embodiment executes the same controls as the controls of the system according to the second embodiment except that, when a set period of time has elapsed from completion of calculation of the correction coefficient, the correction coefficient is cleared and calculated again.

Specifically, the system according to the third embodiment measures an elapsed time after completion of calculation of the correction coefficient. When the elapsed time exceeds the reference period of time ULTIME, the completion flag exfckfin is set to an off state. When the correction coefficient calculation completion flag exfckfin is set to an off state, calculation of the correction coefficient is resumed by the correction coefficient calculation control routine shown in FIG. 18 and FIG. 19, and the correction coefficient is recalculated and updated. The reference time ULTIME is appropriately set to a period of time adequate for updating the correction coefficient, and is stored in the control unit 50 in advance.

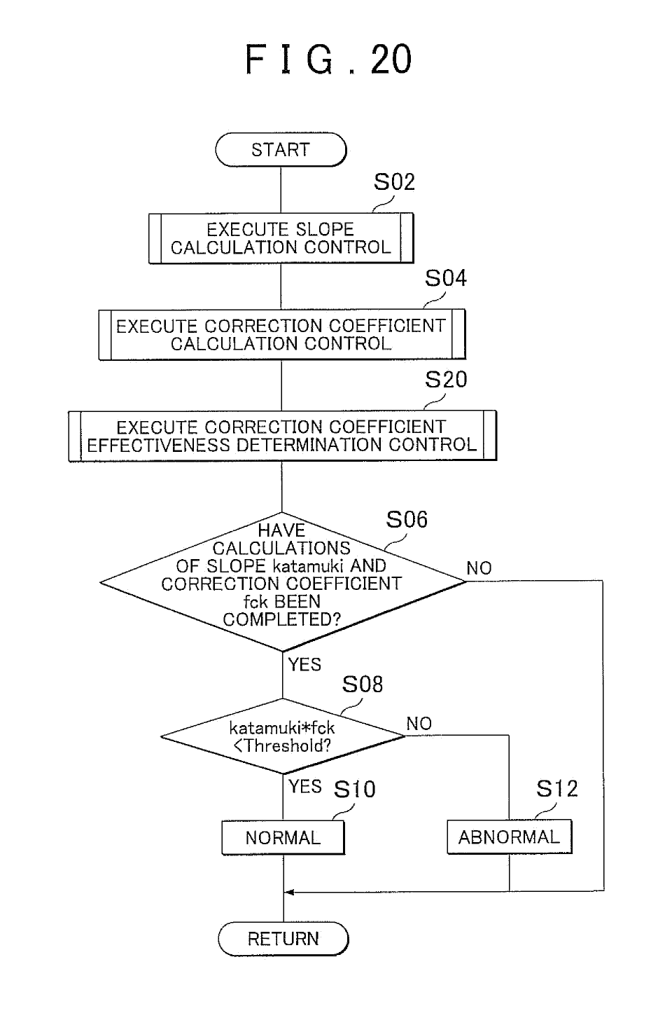

FIG. 20 is a flowchart for illustrating the routine of control that is executed by the control unit 50 in the third embodiment of the invention. The routine shown in FIG. 20 is a routine that is executed instead of the routine shown in FIG. 16, and is the same as the routine shown in FIG. 16 except that the routine shown in FIG. 20 has the process of step S20.

Specifically, when the routine of FIG. 20 is started, the slope calculation control routine (FIG. 17) is started, and subsequently the correction coefficient calculation control routine (FIG. 18 and FIG. 19) is executed. Subsequently, in step S20, a correction coefficient effectiveness determination control routine is executed. The correction coefficient effectiveness control routine will be described later.

After that, as in the case of the routine of FIG. 16, it is determined in step S06 whether calculation of the output slope and calculation of the correction coefficient have been completed. When it is determined that the calculations have been completed, determination as to whether there is an imbalance is made in accordance with the processes of step S08 to step S12.

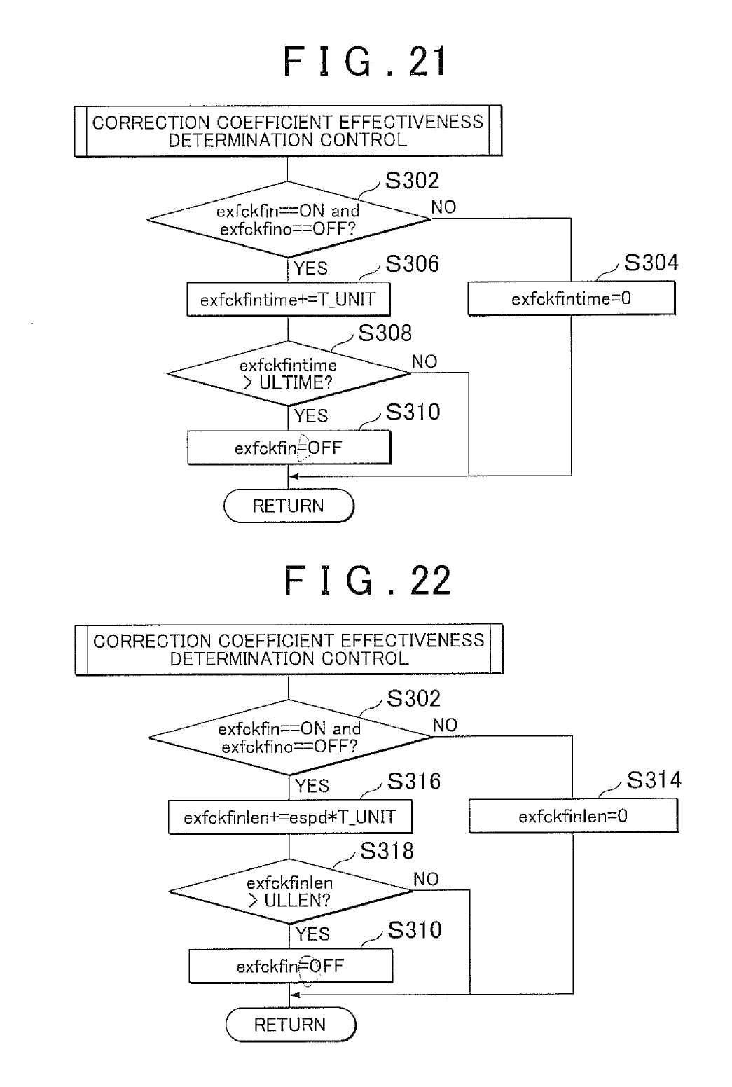

FIG. 21 is a flowchart for illustrating the correction coefficient effectiveness determination control routine that is executed by the control unit 50 in the third embodiment of the invention. In the routine of FIG. 21, it is determined whether the current completion flag exfckfin is in an on state and the last completion flag exfckfin0 is in an off state (i.e., whether a condition that the current completion flag exfckfin is in an on state and the last completion flag exfckfin0 is in an off state is satisfied) (S302). When it is determined that the condition that the current completion flag exfckfin is in an on state and the last completion flag exfckfin0 is in an off state is not satisfied, an elapsed time exfckfintime after calculation of the correction coefficient is set to zero and initialized (S304).

On the other hand, when it is determined that the current completion flag exfckfin is in an on state and the last completion flag exfckfin0 is in an off state (i.e., the condition that the current completion flag exfckfin is in an on state and the last completion flag exfckfin0 is in an off state is satisfied), the elapsed time T_UNIT is added to the elapsed time after calculation of the correction coefficient (S306). Through this process, the elapsed time from when calculation of the correction coefficient fck is completed and the completion flag exfckfin is set to an on state is counted.

Subsequently, it is determined whether the elapsed time exfckfintime after calculation of the correction coefficient is longer than the reference time ULTIME (S308). When it is determined that the elapsed time exfckfintime after calculation of the correction coefficient does not exceed the reference time ULTIME, the current process ends.

When it is determined in step S308 that the elapsed time exfckfintime after calculation of the correction coefficient exceeds the reference time ULTIME, the completion flag exfckfin is set to an off state (S310), after which the current process ends. By setting the completion flag exfckfin to an off state, when the permission flag exfcst is in an on state, affirmative determination is made in step S272 of FIG. 19, so the processes (S274 to S282) of calculating the correction coefficient thereafter are executed. By so doing, the correction coefficient fck is updated.

As described above, according to the third embodiment, when a set period of time has elapsed after completion of calculation of the correction coefficient, the correction coefficient fck is calculated again and is updated. By so doing, for example, even when the responsiveness has changed due to aged degradation of the air-fuel ratio sensor 42, it is possible to use the correction coefficient fck adjusted to the current state of the air-fuel ratio sensor 42. Thus, it is possible to further highly accurately detect an imbalance among the cylinders.

In the third embodiment, the description is made on the case where the correction coefficient fck is recalculated when the elapsed time after calculation of the correction coefficient last time has reached the set period of time. However, the invention is not limited to this configuration. For example, when a travel distance after calculation of the correction coefficient has reached a predetermined travel distance, the process of recalculating and updating the correction coefficient fck may be executed. A specific routine is shown in FIG. 22. The routine of FIG. 22 is the same as the routine of

FIG. 21 except that the processes of step S314 to step S318 are executed instead of the processes of step S304 to step S308.

Specifically, when it is determined in step S302 that the current completion flag exfckfin is in an on state and the last completion flag exfckfin0 is in an off state, a travel distance espd*T_UNIT is added to a travel distance exfckfinlen (S316). By so doing, a travel distance from when the completion flag exfckfin is set to an on state is counted. Subsequently, it is determined whether the travel distance exfckfinlen exceeds a reference travel distance ULLEN. When it is determined that the travel distance excfkflen exceeds the reference travel distance ULLEN, the completion flag exfckfm is set to an off state.

The travel distance is counted in the above process. Therefore, when it is not identified in step S302 that, for example, the completion flag exfckfin is in an on state (i.e., when it is determined in step S302 that, for example, the completion flag exfckfin is in an off state), the travel distance exfckfinlen is cleared to zero in step S314.

The timing at which the correction coefficient is recalculated is not limited to the timing based on the elapsed time exfckfintime or the travel distance exfckfinlen. For example, at a high altitude or in an environment having a different outside atmospheric pressure, the correlation between an FC amplitude rate and an output slope varies. Thus, for example, the configuration may be such that a correction coefficient is calculated for each predetermined region defined by atmospheric pressure, temperature, or the like, and, when it is determined that the current environment is an environment in a region having a different correction coefficient from the currently calculated correction coefficient, the completion flag exfckfin is set to an off state and the correction coefficient is recalculated. In this case, for example, a correction coefficient may be calculated each time the current environment is different from an environment of a region for which the currently used correction coefficient is calculated, or a correction coefficient may be calculated and stored for each region and, only when the current environment is an environment of a region for which calculation of a correction coefficient is not completed, the correction coefficient may be calculated. Furthermore, in the case where the current environment is an environment of a region, when an elapsed time or travel distance after calculation of the correction coefficient of that region is longer than or equal to a set value, the correction coefficient may be calculated. This also applies to the following embodiments.

In the third embodiment, the description is made on the case where the correction coefficient is recalculated in combination with calculation of the correction coefficient according to the second embodiment. However, the invention is not limited to this configuration. For example, in combination with the first embodiment, the pulsation coefficient ki may be recalculated when an elapsed time or travel distance from calculation of the pulsation coefficient ki last time becomes a set value or longer or when the current environment is different from an environment in which the pulsation coefficient ki is calculated. In this case, as in the case of the above, the pulsation coefficient ki may be set for each environment region.

### Fourth Embodiment

A system and air-fuel ratio sensor according to a fourth embodiment respectively have the same configurations as the system and the air-fuel ratio sensor 42 shown in FIG. 1, FIG. 2A and FIG. 2B. In the system according to the fourth embodiment, control different from that of the system according to the second embodiment is executed. More specifically, the control in the fourth embodiment is different from the control in the second embodiment only in that the correction coefficient is calculated in consideration of the influence of the intake air flow rate on the FC amplitude rate.

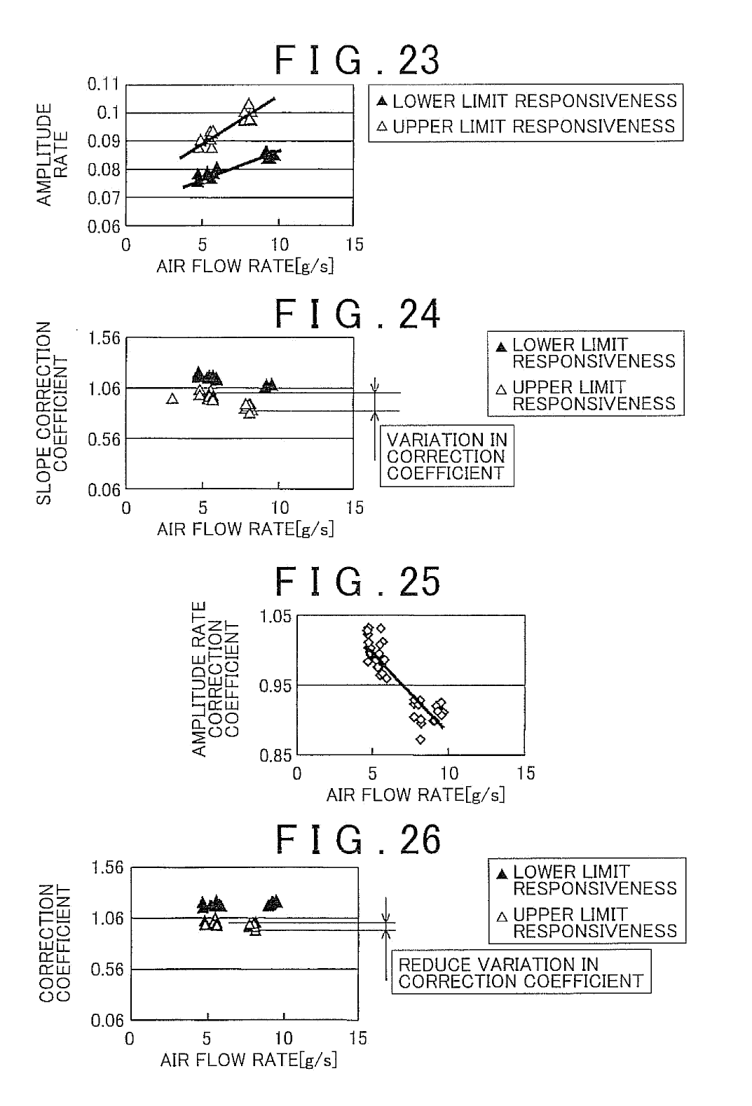

FIG. 23 is a graph for illustrating the correlation between an intake air flow rate and an FC amplitude rate. In FIG. 23, the abscissa axis represents an intake air flow rate, and the ordinate axis represents an FC amplitude rate. It is evident from FIG. 23 that the FC amplitude rate of the air-fuel ratio sensor increases as the intake air flow rate increases regardless of whether the responsiveness is an upper limit or a lower limit of the tolerance, and the air-fuel ratio sensor whose responsiveness is an upper limit has a larger rate of increase in the FC amplitude rate.

FIG. 24 is a graph for illustrating the correlation between an intake air flow rate and a correction coefficient calculated through control according to the second embodiment of the invention. In FIG. 24, the abscissa axis represents an intake air flow rate, and the ordinate axis represents a correction coefficient for an output slope (hereinafter, also referred to as “slope correction coefficient”). As the intake air flow rate increases, the FC amplitude rate varies. Therefore, due to a variation in intake air flow rate at the time when the FC amplitude rate is calculated, there occurs a variation in correction coefficient as shown in FIG. 24. Particularly, when a sensor has a high responsiveness, the influence of the intake air flow rate on the FC amplitude rate is large, so a variation in the calculated slope correction coefficient is large.

FIG. 25 is a graph for illustrating the correlation between an intake air flow rate and an amplitude rate correction coefficient fckk in the fourth embodiment of the invention. In FIG. 25, the abscissa axis represents an intake air flow rate, and the ordinate axis represents an amplitude rate correction coefficient fckk. As shown in FIG. 25, the correction coefficient for the FC amplitude rate (amplitude rate correction coefficient) is obtained on the basis of the intake air flow rate at which the FC amplitude rate is calculated. The amplitude rate correction coefficient fckk is set such that the influence of the intake air flow rate on the FC amplitude rate is excluded from the correlation between an intake air flow rate and an FC amplitude rate, shown in FIG. 23. Specifically, the amplitude rate correction coefficient fckk is set so as to decrease as the intake air flow rate increases. The correlation between an amplitude rate correction coefficient fckk and an intake air flow rate is obtained through an experiment, simulation, or the like, in advance and is set as a map, or the like, and is then stored in the control unit 50. At the time when control is executed, the amplitude rate correction coefficient fckk corresponding to the intake air flow rate is obtained in accordance with the map, or the like, and the FC amplitude rate is corrected.

FIG. 26 is a graph for illustrating the correlation between an intake air flow rate and a slope correction coefficient calculated using an FC amplitude rate corrected by the amplitude rate correction coefficient fckk in the fourth embodiment of the invention. As shown in FIG. 26, by calculating a slope correction coefficient using an FC amplitude rate corrected such that the influence of an intake air flow rate is removed, a variation in the slope correction coefficient with respect to an intake air flow rate is reduced. Thus, by using such a correction coefficient, it is possible to further accurately detect an imbalance.

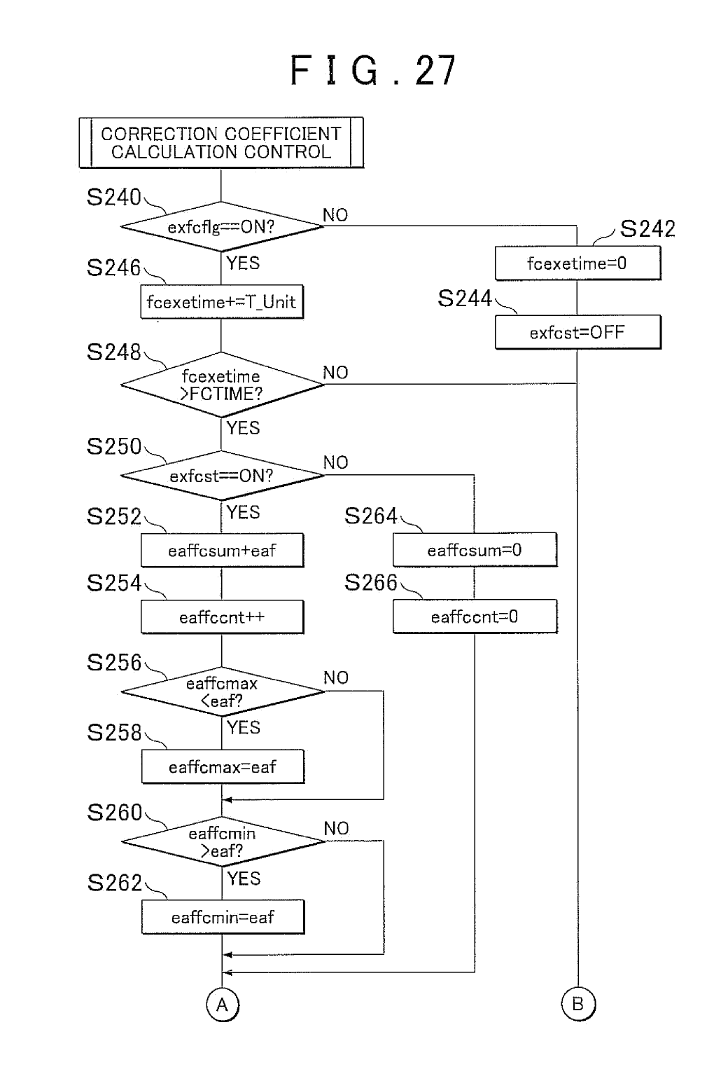

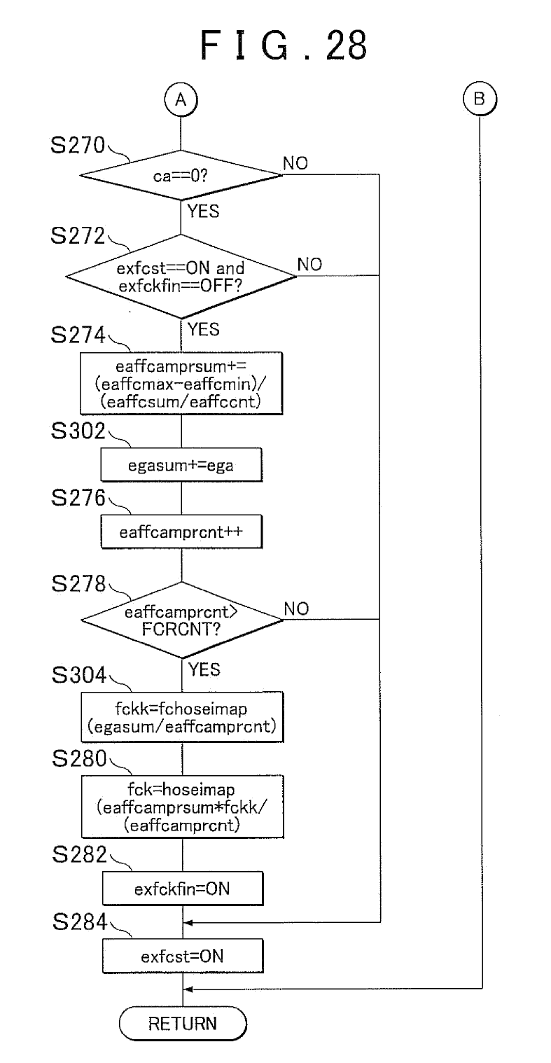

FIG. 27 and FIG. 28 are flowcharts for illustrating the routine of control that is executed by the control unit 50 in the fourth embodiment of the invention. The routine shown in FIG. 27 and FIG. 28 is a routine that is executed instead of the routine shown in FIG. 18 and FIG. 19, and is the same as the routine shown in FIG. 18 and FIG. 19 except that the routine has the process of step S302 after step S274 and has the process of step S304 after step S278.

Specifically, when it is determined in step S272 that the permission flag exfcst is in an on state and the completion flag exfckfin is in an off state, and the FC amplitude rate accumulated value is calculated in step S274, a current intake air flow rate ega is subsequently accumulated into an intake air flow rate accumulated value egasum (S302). The intake air flow rate ega is obtained on the basis of the output of the air flow meter 34. After that, the accumulation number eaffcamprcnt is accumulated (S276). Here, the accumulation number is not only the number of accumulation of the FC amplitude rate but also a counter that counts the number of accumulation of the intake air flow rate.

Subsequently, when it is determined in step S278 that the accumulation number eaffcamprcnt exceeds the reference number FCRCNT, the amplitude rate correction coefficient fckk for the FC amplitude rate is calculated in step S304. The correlation between the intake air flow rate egasum and the amplitude rate correction coefficient fckk is stored in the control unit 50 in advance.

Subsequently, in step 280, the slope correction coefficient fck is calculated. In this calculation, the FC amplitude rate corrected by the correction coefficient fckk calculated in step S304 is used.

As described above, in the fourth embodiment, correction is made using the intake air flow rate. Thus, it is possible to remove a variation in output slope due to the intake air flow rate, so it is possible to further accurately detect an imbalance.

In the fourth embodiment, the description is made on the case where correction based on the intake air flow rate is made on the FC amplitude rate. However, the invention is not limited to this configuration. For example, an output slope may be corrected on the basis of the intake air flow rate such that the influence of a fluctuation in amplitude rate due to the intake air flow rate on the output slope is removed. In addition, for example, the threshold Threshold in imbalance determination may be corrected on the basis of the intake air flow rate.

In the fourth embodiment, the description is made on the case where correction based on the intake air flow rate is combined with control according to the second embodiment. However, the invention is not limited to this configuration. For example, control for recalculating the correction coefficient on the basis of an operating time, a travel distance, an outside atmospheric pressure, or the like, as in the case of the third embodiment may be further combined with the fourth embodiment.

In the above-described embodiments, when a numerical value, such as number, quantity, amount and range, of each element is described, unless otherwise specified or clearly specified to that numerical value in theory, the invention is not limited to the described numerical value. In addition, the structures, and the like, described in the embodiments are not necessarily indispensable for the invention unless otherwise specified or clearly specified to that structures in theory.

What is claimed is:

1. An air-fuel ratio imbalance detection apparatus for an internal combustion engine, comprising:
an air-fuel ratio sensor that is arranged in an exhaust passage of the internal combustion engine and that includes an electrode and a diffusion layer provided on the electrode;
an estimating unit configured to estimate or detect an output variation amount that is an amount of variation in an output of the air-fuel ratio sensor due to an influence of a pressure pulsation of exhaust gas from the internal combustion engine; and
a determination unit configured to determine whether there is an air-fuel ratio imbalance among cylinders of the internal combustion engine, on the basis of the output variation amount and a determination value based on the output of the air-fuel ratio sensor.

2. The air-fuel ratio imbalance detection apparatus according to claim 1, wherein the estimating unit estimates or detects an amplitude of the output of the air-fuel ratio sensor or a value corresponding to the amplitude, as the output variation amount.

3. The air-fuel ratio imbalance detection apparatus according to claim 1, wherein the estimating unit estimates or detects the output variation amount on the basis of the output of the air-fuel ratio sensor during fuel cut operation of the internal combustion engine.

4. The air-fuel ratio imbalance detection apparatus according to claim 1, further comprising:
a first unit configured to estimate or detect a pressure pulsation that is received by a sensor element of the air-fuel ratio sensor due to the pressure pulsation of exhaust gas from the internal combustion engine; and
a second unit configured to estimate or detect a first amplitude that is an amplitude of the output of the air-fuel ratio sensor, and to estimate or detect a second amplitude that is an amplitude of the output of the air-fuel ratio sensor at timing at which the pressure pulsation received by the sensor element is different from the pressure pulsation at a time when the first amplitude is estimated or detected, wherein
the estimating unit estimates the output variation amount on the basis of a difference between the first amplitude and the second amplitude and a difference between the pressure pulsation at the time when the first amplitude is estimated or detected and the pressure pulsation at a time when the second amplitude is estimated or detected.

5. The air-fuel ratio imbalance detection apparatus according to claim 4, wherein the estimating unit estimates or detects the output variation amount on the basis of the output of the air-fuel ratio sensor during fuel cut operation of the internal combustion engine.

6. The air-fuel ratio imbalance detection apparatus according to claim 4, wherein timing at which the first amplitude is estimated or detected and the timing at which the second amplitude is estimated or detected are (i) timings during fuel cut operation of the internal combustion engine, (ii) timings which are during a stop of air-fuel ratio feedback control, and at which a same target air-fuel ratio is set, or (iii) timings which are during the air-fuel ratio feedback control, and at which a same target air-fuel ratio that falls outside a reference range including a stoichiometric air-fuel ratio is set.

7. The air-fuel ratio imbalance detection apparatus according to claim 4, further comprising:
a third unit configured to set a target air-fuel ratio to a rich or lean air-fuel ratio that falls outside a reference range including a stoichiometric air-fuel ratio when air-fuel ratio feedback control operation of the internal combustion engine is being performed and the target air-fuel ratio is set so as to fall within the reference range; and
a fourth unit configured to execute control for forcibly fluctuating the pressure pulsation when the feedback control operation is being performed with the target air-fuel ratio being set to the rich or lean air-fuel ratio, wherein
timing at which the first amplitude is estimated or detected and the timing at which the second amplitude is estimated or detected are during the control for forcibly fluctuating the pressure pulsation.

8. The air-fuel ratio imbalance detection apparatus according to claim 1, further comprising:
a fifth unit configured to determine that there is an abnormality in the air-fuel ratio sensor when the output variation amount falls outside a predetermined range.

9. The air-fuel ratio imbalance detection apparatus according to claim 1, wherein the determination value is an amplitude of the output of the air-fuel ratio sensor in one cycle of the internal combustion engine when it is determined whether there is the air-fuel ratio imbalance.

10. The air-fuel ratio imbalance detection apparatus according to claim 1, wherein the determination value is a rate of variation in the output of the air-fuel ratio sensor per unit crank angle.

11. The air-fuel ratio imbalance detection apparatus according to claim 1, wherein the determination unit determines that there is the air-fuel ratio imbalance when a value obtained by correcting the determination value on the basis of the output variation amount exceeds a reference value.

12. The air-fuel ratio imbalance detection apparatus according to claim 1, wherein the determination unit determines that there is the air-fuel ratio imbalance when the determination value exceeds a value obtained by correcting a reference value on the basis of the output variation amount.

13. The air-fuel ratio imbalance detection apparatus according to claim 1, wherein when an operation time of the internal combustion engine exceeds a reference time or a travel distance of a vehicle on which the internal combustion engine is mounted exceeds a reference distance after the estimating unit estimates or detects the output variation amount, the estimating unit estimates or detects the output variation amount again.

14. The air-fuel ratio imbalance detection apparatus according to claim 3, wherein the determination unit determines whether there is the air-fuel ratio imbalance on the basis of the output variation amount, an intake air flow rate during a period in which the output variation amount is estimated or detected, and the determination value.
